(19) United States
(12) Patent Application Publication
(10) Pub. No.: US 2018/0300793 A1
(43) Pub. Date: Oct. 18, 2018

(54) AUGMENTING SUSTAINABLE PROCUREMENT DATA WITH ARTIFICIAL INTELLIGENCE

(71) Applicant: Workpology, Inc., San Francisco, CA (US)

(72) Inventors: Angela Chen, San Diego, CA (US); James Henry Tull, San Francisco, CA (US)

(73) Assignee: Workpology, Inc., San Francisco, CA (US)

(21) Appl. No.: 15/951,066

(22) Filed: Apr. 11, 2018

Related U.S. Application Data
(60) Provisional application No. 62/484,843, filed on Apr. 12, 2017.
(60) Provisional application No. 62/558,831, filed on Sep. 14, 2017.

(51) Int. Cl. G06Q 30/06; G06N 5/04

(52) U.S. Cl. CPC G06Q 30/0631; G06N 5/048

(57) ABSTRACT

Receiving, by a computing system, specification data relating to a first set of specifications, the specification data comprising a plurality of product categories, a plurality of impact areas associated with each product category of the plurality of product categories, a plurality of offsets, each offset associated with an impact area, and a plurality of products, each product associated with a subset of impact areas of the plurality of impact areas and a subset of offsets of the plurality of offsets. A product benefit efficiency score may be calculated for each product of the plurality of products based on the subset of impact areas and the subset of offsets associated with each product. One or more product recommendations may be determined for a user based on the product benefit efficiency scores.

### CROSS-REFERENCE TO RELATED APPLICATIONS

The present application claims the benefit of U.S. Provisional Patent Application Ser. No. 62/484,843, filed Apr. 12, 2017 and entitled “Systems and Methods for Ensuring Product Sustainability Signals from Phylogenetic Methods,” and U.S. Provisional Patent Application Ser. No. 62/558,831, filed Sep. 14, 2017 and entitled “Augmenting Sustainable Procurement Outcomes and ROI with Artificial Intelligence and True Value Engineering,” which are hereby incorporated by reference herein.

### TECHNICAL FIELD

This disclosure pertains to systems for augmenting data with artificial intelligence and machine learning.

### BACKGROUND

Under conventional approaches, sustainability information may be used to determine whether products or entities conform to sustainability standards. For example, static methods may be used to determine whether an entity conforms to sustainability standards. However, conventional approaches for determining whether an entity conforms to sustainable standards are often inconsistent, unclear, inaccurate, and rigid.

### SUMMARY

A claimed solution rooted in computer technology overcomes problems specifically arising in the realm of computer technology. In various embodiments, systems, methods, and non-transitory computer readable media are configured to receive specification data relating to a first set of specifications, the specification data comprising a plurality of product categories, a plurality of impact areas associated with each product category of the set of product categories, a plurality of offsets, each offset associated with an impact area, and a plurality of products, each product associated with a subset of impact areas of the plurality of impact area and a subset of offsets of the set of offsets. A product benefit efficiency scores may be calculated for each product of the plurality of products based on the subset of impact areas and the subset of offsets associated with each product. One or more product recommendations may be determined for a user based on the product benefit efficiency scores

In some embodiments, the product benefit efficiency score for a product is indicative of a sustainability of the product. In some embodiments, the product benefit efficiency score for a product is indicative of how effectively the set of offsets associated with the product offset the set of impact areas associated with the product.

In some embodiments, the systems, methods, and non-transitory computer readable media further configured to determine that a first product category of the set of product categories is similar to a second product category of the set of product categories; and associate one or more impact areas associated with the second product category with the first product category based on the determining that the first product category is similar to the second product category.

In some embodiments, the systems, methods, and non-transitory computer readable media further configured to calculate a true value for at least some products of the plurality of products, wherein the determining one or more product recommendations for a user based on the product benefit efficiency scores comprises determining one or more product recommendations for the user based on the true values. In some embodiments, a true value for a product comprises a quotient of a price associated with the product divided by a product benefit efficiency score associated with the product.

In some embodiments, the systems, methods, and non-transitory computer readable media further configured to calculate a product benefit efficiency score threshold for each product category of the plurality of product categories based on the product benefit efficiency scores, wherein the determining one or more product recommendations for a user based on the product benefit efficiency scores comprises determining one or more product recommendations for a user based on the product benefit efficiency score thresholds.

In some embodiments, the systems, methods, and non-transitory computer readable media further configured to receive purchase order information associated with a purchase order made by the user, the purchase order information comprising one or more products purchased by the user, an amount of spend for each product of the one or more products, and a total spend for the purchase order; and calculate a green spend efficiency for the set of purchases, wherein the green spend efficiency is indicative of a proportion of the total spend that was spent on products that satisfy the product benefit efficiency score threshold.

In some embodiments, the systems, methods, and non-transitory computer readable media further configured to receive current product information comprising a set of products that have been previously purchased by the user, the set of products comprising products within a plurality of product categories; and identify alternative product recommendations for at least a subset of the set of products based on the product benefit efficiency scores. In some embodiments, the identifying alternative product recommendations for at least a subset of the set of products comprises calculating at least one of a product benefit efficiency score improvement rate or a green spend efficiency improvement rate for each product in the subset of products and the alternative product recommendations.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 depicts a diagram of an example system for augmenting, managing and analyzing sustainability information using artificial intelligence according to some embodiments.

FIG. 2 depicts a diagram of an example of an augmented sustainability management and analytics system according to some embodiments.

FIG. 3 depicts a flowchart of an example of a method of determining one or more product recommendations for a user based on product efficiency scores according to some embodiments.

FIG. 4 depicts an example matrix demonstrating different impact areas according to some embodiments.

FIG. 5 depicts a chart showing example product categories and labels according to some embodiments.

FIGS. 6A-B depict an example use case according to some embodiments.

FIG. 7 depicts an example annotation tool interface generated according to some embodiments.

FIG. 8 depicts example worksteps involved in manufacture of a number of different product categories according to some embodiments.

FIG. 9 depicts an example list of impact areas according to some embodiments.

FIG. 10 depicts example impact areas mapped onto United Nations' Sustainable Development Goals according to some embodiments.

FIG. 11 depicts an example graph database to visualize results according to some embodiments.

FIG. 12 depicts an example threshold curve according to some embodiments.

FIG. 13. depicts an example graph according to some embodiments.

FIG. 14 depicts example data sources and example sustainability benefit offsets and impact liabilities of categorical products and services according to some embodiments.

FIG. 15 depicts a diagram of an example of a computing device according to some embodiments.

### DETAILED DESCRIPTION

A claimed solution rooted in computer technology overcomes problems specifically arising in the realm of computer technology. In various embodiments, a computing system is configured to provide flexible, consistent, accurate, and easily interpreted information related to determining whether an entity (e.g., an organization) and/or products (e.g., manufactured products) satisfy specification requirements (e.g., as defined by a sustainability standards organization). The system may also recommend actions (e.g., adjusting manufacturing processes) that will cause an entity and/or product to satisfy specification requirements. In some embodiments, the system provides users (e.g., sustainability officers, chief procurement officers, and/or the like) a clearer sustainability and/or cost picture, and handles different types of purchase order records and product category policies and environmental product declarations in a single location. The system may be directed at sustainability leaders and strategic procurement users, giving them customizable reporting to visualize and communicate relevant green spend information, and improve on green spend performance for greater cost savings and sustainability gains.

In some embodiments, the system may be applicable to a variety of fields, such as product sustainability, sustainable purchasing programs, supplier sustainability programs, and/or the like. Product sustainability may include product evaluation, circular economy, certifications and standards, integrating product information into eProcurement/eCatalogs/ERP, product ingredient transparency, and/or the like. Sustainability purchasing programs may include providing sustainable purchasing policies (EPP Policy Builder), providing sustainable purchasing products (e.g., greener product recommender), sustainability-related spend analysis, and/or the like. Sustainability-related spend analysis may include motivating sustainable purchasing/behavior, tracking sustainable purchasing/behavior, benchmarking sustainable purchasing/behavior, and/or the like. Supplier sustainability may include supplier engagement/development, supplier evaluation/score-carding supplier diversity, auditing for supplier compliance, supply chain transparency/traceability, and/or the like.

The present disclosure includes an intelligent sustainability management system including set of analytical tools that allow procurement organizations to be fiscally sustainable, as well as reduce resources (e.g., computing resources) required to satisfy various sustainability standards. In some embodiments, the system enables procurement breakdowns and cost differentials for presentation by use by calculating average deltas in pricing information of product attributes and impact offsets. Users may then be able to acknowledge which brands to consider and what they are charging on average.

Accessing product information by identifying processes (e.g., how things were made) that are important to users, and customizing product recommendations specifically catered to their requirements and transparent environmental product declarations may be of importance to both rule-based and value-based buyers and sellers. In showing buyers and sellers how new ways of aggregating and integrating existing data can help them make faster, more accurate purchasing decisions that benefit our planet, people, local economies, public procurement organizations like cities and schools can save many hours per year (e.g., 10,000-50,000) in time freed up by the system, and between 2%-5% cost savings on average for categories in which economies of scale have been achieved for green purchasing by our analytics, and previously undiscovered local vendors with sustainable practices can gain market visibility by the datasets described herein.

In various embodiments, the system recognizes natural capital models of capitalism, covering standards and/or criteria (e.g., expressed herein as impact liabilities or “liabilities”) and claims and/or disclosures (e.g., expressed herein as impact offsets, offsets, or “benefits”), and builds on a common denominator of impact offset measurements called spend efficiency as the integrating principle of procurement science. Moreover, if decision theory and game theory are broadened to encompass other-regarding preferences, they may become capable of modeling all aspects of decision making involved in finding, comparing, purchasing, tracking and reporting on product information, including those normally considered for cost (finance), quality (end user) and compliance (health and safety, sustainability). This knowledge for the conscious economy based on impact offsets per dollar spent in each category under management may then become the organizing principle of procurement, merchandising, manufacturing, certification and regulation in service of sustainability and resilience.

In some embodiments, buyers need information to make good decisions. Each time buyers purchase a commodity, the buyers are voting for the kind of world they want to live and work in. Demand for a product supports its continued manufacture and therefore the sustainability practices of the brands that make them along the entire supply chain. In this way, purchasing dollars become a powerful asset in influencing sustainability (e.g., environmental impacts on the planet, social impacts on people and animals, and fiscal impacts on local economies).

When consumers (or, “buyers”) care, competitive brands listen and manufacturers do things differently, but current methods of reporting product information have been ineffective. Barriers to positive change include the impractical, costly, or unavailable flow and exchange of information between consumers, manufacturers, retailers, regulators, and third party certifiers in the marketplace ecosystem. With multiple sources of information (e.g., CSR reports that are impractical to read, 450+ ecolabels that are confusing to know, certification that is costly to acquire, ecolabel updates that are hard to track, and green marketing jargon that is hard to trust), reporting of product information has been ineffective, and information asymmetry has plagued decision-making for all parties.

In some situations, procurement officers must, as performance measures, provide reconcilable ROI value to multiple stakeholders, such as end users (product utility), finance (product cost savings), and compliance (product conformity to sustainability and safety standards). If the product, good, or service being considered for purchase does not meet these specifications and create optimized value in conformance to various demands, the procurement officer does not fund it and the vendor selling the product does not win or renew the bid contract or the sale. As used herein, “product” may refer to physical products (e.g., manufactured products), software and/or hardware systems, services, and/or the like.

Value itself can be created and defined in procurement with regard to cost savings and sustainability gains. While traditional benchmarks have focused in on high-level pricing strategies and cooperative purchasing agreements through outsourcing, new data sources and metrics can tap underlying internal performance dynamics to offer better visibility to hidden sources of better supply-chain performance at buy-side organizations. Value in procurement can now be created in a way that quantifies the benefit created within the constraints of policy and budgetary specifications. An example need is commonly found at municipal government and other public procurement organizations, where holding budgets constant in search of sustainability gains, or meeting minimal compliance thresholds in search of the least expensive way there are necessary.

When a buy-side procurement organization consumes goods and services that are within budgetary allowances, serves the utility functions needed by the end user, and is in alignment to its environmentally preferable purchasing policies (EPP's), it becomes effective at generating an efficient return on investment (ROI) for the organization's triple bottom lines of cost, utility, and sustainability needs.

In some embodiments, because many vendors and suppliers are submitting product offerings to compete for purchasing dollars, and because these purchasing dollars may be public tax-payer monies being spent in small but manifold incremental amounts, there is a heavy dependence on product category management and transparent decision-making frameworks to aid in quantitative and qualitative assessment at the point-of-purchase.

In some embodiments, this benefit is measured herein as a “Benefit and Liability” calculator and works by accounting for the impact offset per dollar spent, normalized for any category of good or service. Purchasers can access these metrics through an analysis of their purchase records to demonstrate the value of their sustainable procurement to management (city directors, managers, chief finance officers as beneficiaries). The calculators provide a good new resource across environmental, social, and fiscal dimensions of sustainability that represent an industry first.

The ability to automatically find products and suppliers meeting environmentally preferable purchasing requirements based on its supply chain manufacturing attribute conformity (tied to its benefit performance) would save the U.S. government 5 million hours/year ($300M) in manual research time by simplifying how they analyze and report on product information from suppliers, and potentially shift one trillion dollars in public sector spending or ten trillion dollars in private sector spending toward more sustainable decisions in alignment to desired outcomes for sustainability. Getting there means removing the barriers to consuming more sustainably: institutional buyer knowledge at the point of purchase decision-making, and mechanisms for seller transparency and disclosures that reward for sustainable production practices.

Product meta-data, evaluation, and reporting may be needed by cities and schools to save time and money when making purchasing decisions at scale. Federal acquisition regulations mandated by executive order established in 2013 require all government-selected products or vendors be sustainable, but being told to buy sustainably may be meaningless without effectively comparing products. Furthermore, products cannot be effective compared without a method to calibrate and normalize standards between and/or within categories of products (e.g., foods, goods, services), and without access to product information that is translatable back to the buyer's specifications.

In some embodiments, a paradigm shift for consumption and/or production is needed from the top-down. Governments have a systems-level infrastructure opportunity for increasing the transparency of environmental, social, and fiscal impacts behind the things they buy with regulatory compliance. The system described herein may provide analytics and footprint tracking platform to improve reporting and long-term sustainability planning, and organization (e.g., government agencies) may be able to draw meaning from existing meta-data sources (E.g., corporate metadata sources) with machine learning to cross-reference highest impact areas of millions of goods and services based on production-level specifications, attributes, and certifications.

In some embodiments, the system may utilize a framework to compare the data put forth by suppliers, buyers, policy makers, third party certifiers, and trusted organizations representing voluntary consensus groupings of certifications deemed reflective of the market. Some examples of such data sources can include:
(A) Vendor Catalogue offerings or Supplier Submittals
(B) Procurement Purchase Order Records
(C) EPPs: These new government purchasing requirements equal time and money spent internally making sure suppliers are green, ethical, and locally sourced.
(D) Third-Party Certifications and Standards
(E) Voluntary Consensus Standards Developers: EPA Recommended Guidelines, ANSI Accredited Certifications

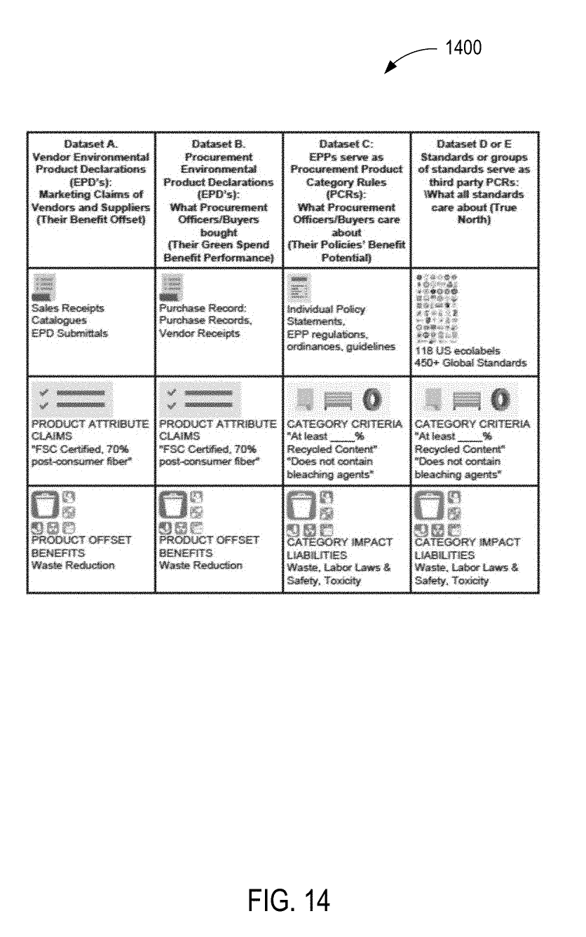

In some embodiments, the system can quantify the sustainability benefit offsets and impact liabilities of categorical products and services to compare, for example: A vs. B, A vs C, A vs. D, A vs. E, B vs. C, B vs. D, B vs. E, C vs. D, C vs. E, D vs. E. Examples of A, B, C, D, and E are shown in FIG. 14.

In some embodiments, A vs. B, A vs C, A vs. D, A vs. E allows the system to ensure that suppliers are meeting the standards that buyers request, that ecolabels certify for, and that purchasers audit for. B vs. C, B vs. D, B vs. E relate the purchases of a public body to their own policy expectations and the “true north” or best practices available on the market today. C vs. D, C vs. E score a public policy against the “true north,” and with this data the system may recommend improved policies across product categories. D vs. E compares ecolabels to the standard certifiers themselves.

In the sections that follow, data sources, such as those introduced above, are used to create a dataset of structured data that can be utilized to make various comparisons, calculations, and determinations, which are introduced in the later sections.

In various embodiments, the present disclosure offers a data-driven sustainability management system which uses structured datasets to help organizations accurately measure, mitigate, and report on their total consumption environmental and social impact from procurement spend. Its solutions also enable sell-side organizations to measure, market, and monetize sustainability attributes found in their internal operations and supply chain whose production value is captured in end products for merchandising and marketing intelligence.

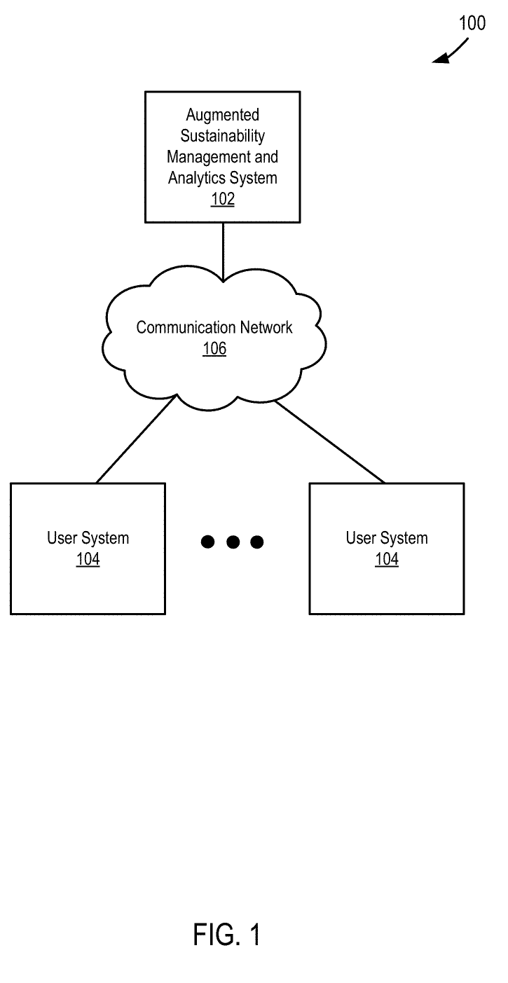

FIG. 1 depicts a diagram 100 of an example system for augmenting, managing and analyzing sustainability information using artificial intelligence according to some embodiments. In the example of FIG. 1, the system includes an augmented sustainability management and analytics system 102, user systems 104-1 to 104-N (individually, the user system 104, collectively, the user systems 104), and a communication network 106.

The augmented sustainability management and analytics system 102 may function to integrate, manage, augment, and intelligently analyze and present sustainability information and/or information related thereto. Sustainability information may include specification requirements (e.g., requirements for satisfying one or more sustainability standards), product information (e.g., materials used to manufacture a product), and/or the like. The system 102 may implement machine learning to analyze sustainability information to determine whether an entity (e.g., an organization) and/or product (e.g., a product provided by an entity) satisfy specification requirements. The system 102 may also augment sustainability information by analyzing (e.g., using machine learning) sustainability information to determine recommendations for entities or products to satisfy specification requirements. Functionality of the augmented sustainability management and analytics system 102 may be performed by one or more servers (e.g., a cloud-based server) and/or other computing devices (e.g., desktop computers, laptop computers, mobile devices, and/or the like).

In some embodiments, the augmented sustainability management and analytics system 102 functions to annotate data for facilitating machine learning analytics. Generally, data-driven sustainability management begins with a foundational understanding of work processes (e.g., processes/steps undertaken to make and sell a product, and work performed may result in impact liabilities, but certain practices/some worksteps can offset impact liabilities). Product-manufacturing processes may be broken down into various product stages. For example, in one embodiment, the product manufacturing process can generally be broken down into six different stages: pre-production, production, packaging, distribution, use/consumption, and disposal.

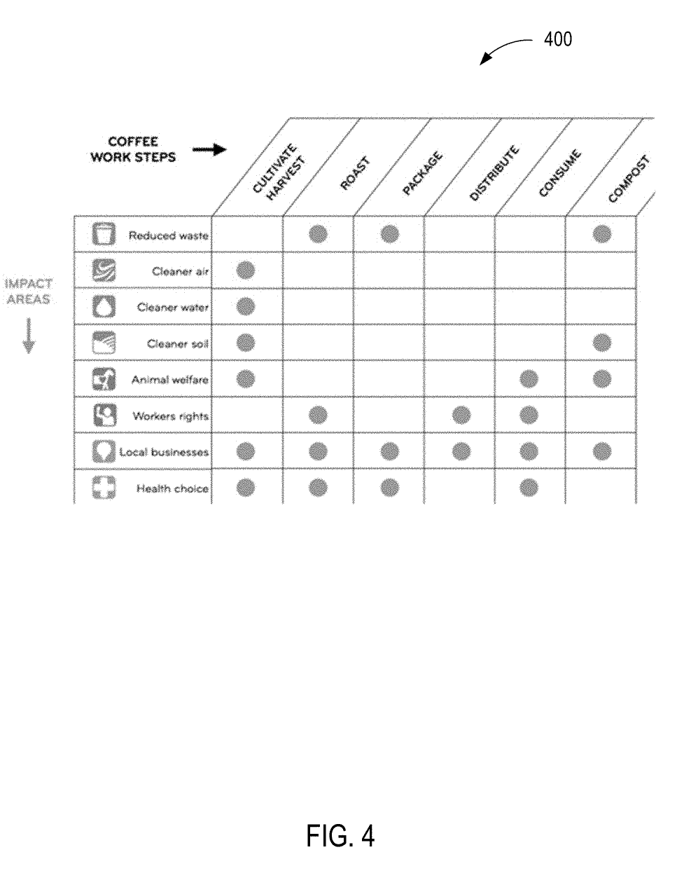

Various product categories (e.g., paper, coffee, toner, displays, phones, etc.) may have different environmental, fiscal, and/or social impacts at each stage of production. FIG. 4 provides an example matrix demonstrating different example impact areas affected by production of coffee at each production stage (or work step). In the example of FIG. 4, the six production stages (e.g., pre-production, production, packaging, distribution, use/consumption, and disposal) have been swapped out for terms more specific to production of coffee (e.g., cultivate/harvest, roast, package, distribute, consume, and compost).

In some embodiments, each product category can also be associated with a set of “practices.” In general, a practice is a criteria that a particular specification deems important for a product category with regards to addressing an impact area.

In some embodiments, in order to determine the various impact areas and practices that may be relevant to a particular product category, various data sources, such as those discussed above, can be collected, and annotated into a structured data set. The structured data set can be analyzed to identify, for each product category, which impact areas and practices are relevant to each product category, and, in some embodiments, at which production stage within the product category.

In some embodiments, the augmented sustainability management and analytics system 102 utilizes machine learning and statistical methods to calculate the similarity between practices. Patterns and latent structures in the datasets underpinning sustainability have been seldom explored and our methods elucidate correlations and patterns between practices/standards and product categories.

In some embodiments, the augmented sustainability management and analytics system 102 utilizes machine learning to infer product sustainability from phylogenetic methods to fill in unknown Product Category Rules, Liability Impact areas and also Environmental Product Declarations and Benefit Offset Opportunities with 3 relationship trees using phylogenetic methodology. Phylogenetic methods can be used by our platform to create a “Work” Tree where Shared Supply Chain Practices form the relationships between categories and thus allow for inferences to be made about shared liabilities.

In some embodiments, the augmented sustainability management and analytics system 102 functions to determine where true value (e.g., not just product cost savings or utility benefits but also sustainability benefits realized through optimal practices without necessarily increasing prices paid) can be captured for a user (e.g., a customer).

In some embodiments, the augmented sustainability management and analytics system 102 functions to provide measure called “Green Spend Potential” (e.g., defined by a “Green Spend Potential Score”) when speaking about the potential performance of policies in harnessing spend or “Green Spend Performance” (e.g., defined by a “Green Spend Efficiency Score”) when speaking about the actual spend performance based on historical purchase order records of an organization's spend on capital and operational expenditure goods and services.

In some embodiments, the augmented sustainability management and analytics system 102 functions to perform sustainability comparisons quantitative in determining product recommendations and also to allow for quantitative comparisons between products. In various embodiments, the method by which such quantification is made can be specific within environmental, social, and economic factors at the impact level, but can also be combined at the product category level.

In some embodiments, the augmented sustainability management and analytics system 102 functions to determine “best practices” for product categories. Best practices can be provided as recommendations to various organizations to assist the organizations in crafting purchasing/environmental policies. In various embodiments, determinations of “best practices” are made based on crowd intelligence and/or network-based reasoning.

The user systems 104 may function to present information, receive input, and otherwise interact with one or more users and/or systems (e.g., augmented sustainability management and analytics system 102). For example the user systems 104 may generate and/or present various graphical user interfaces. In various embodiments, functionality of the user systems 104 may be performed by one or more computing devices.

The communications network 106 may represent one or more computer networks (e.g., LAN, WAN, or the like) or other transmission mediums. The communication network 106 may provide communication between systems 102 and 104, and/or other systems, engines, and/or datastores described herein. In some embodiments, the communication network 106 includes one or more computing devices, routers, cables, buses, and/or other network topologies (e.g., mesh, and the like). In some embodiments, the communication network 106 may be wired and/or wireless. In various embodiments, the communication network 106 may include the Internet, one or more wide area networks (WANs) or local area networks (LANs), one or more networks that may be public, private, IP-based, non-IP based, and so forth.

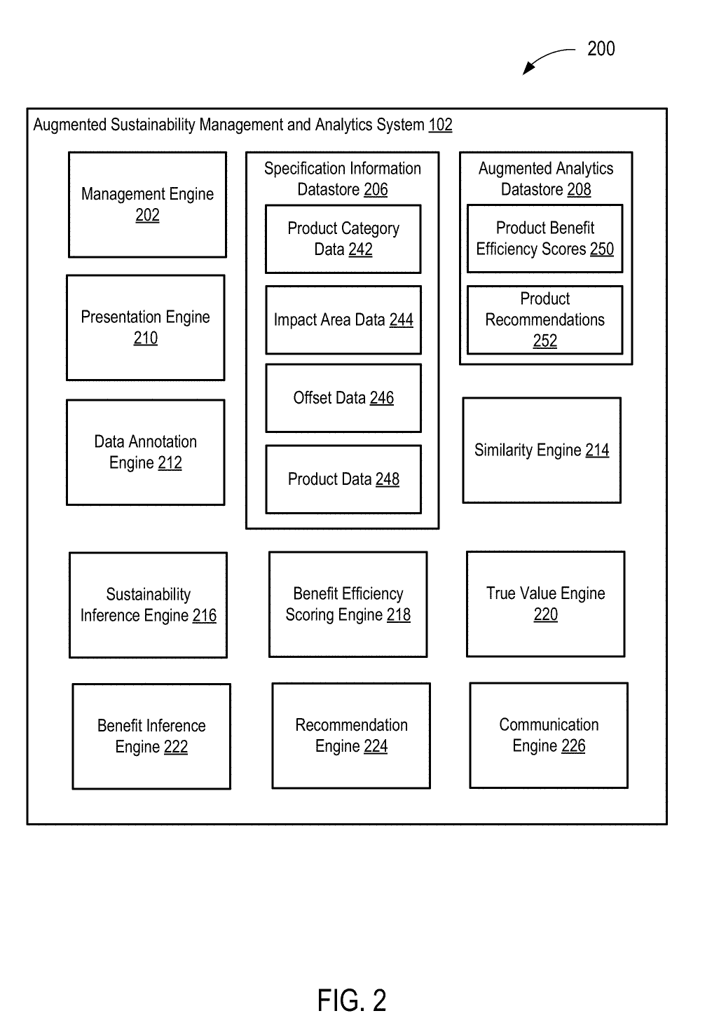

FIG. 2 depicts a diagram 200 of an example of an augmented sustainability management and analytics system 102 according to some embodiments. In the example of FIG. 2, the augmented sustainability management and analytics system 102 includes a management engine 202, a specification information datastore 206, an augmented analytics datastore 208, a presentation engine 210, a data annotation engine 212, a similarity engine 214, a sustainability inference engine 216, a benefit efficiency scoring engine 218, a true value engine 220, a benefit inference engine 222, a recommendation engine 224, and a communication engine 226.

The management engine 202 may function to manage (e.g., create, read, update, delete, or otherwise access) specification data 240 stored in the specification information datastore 206, and product benefit efficiency scores 250 and product recommendations 252 stored in the augmented analytics datastore 208, and/or other data stored in other datastores. The management engine 202 may perform any of these operations manually (e.g., by a user interacting with a GUI) and/or automatically (e.g., triggered by one or more of the engines 210-226, discussed herein). In some embodiments, the management engine 202 includes a library of executable instructions, which are executable by one or more processors for performing any of the aforementioned management operations. Like other engines described herein, functionality of the management engine 202 may be included in one or more other engines (e.g., engines 210-226).

As used herein, specifications may include specification requirements for satisfying one or more specification standards and/or other types of specifications. For example, the specification requirement may define requirements to earn a label and/or credential (e.g., “green”). In some embodiments, specification data 240 is related to one or more specifications, and may include product category data 242, impact area data 244, offset data 246, and product data 248. The data 240-248 may be raw and/or annotated, as discussed elsewhere herein.

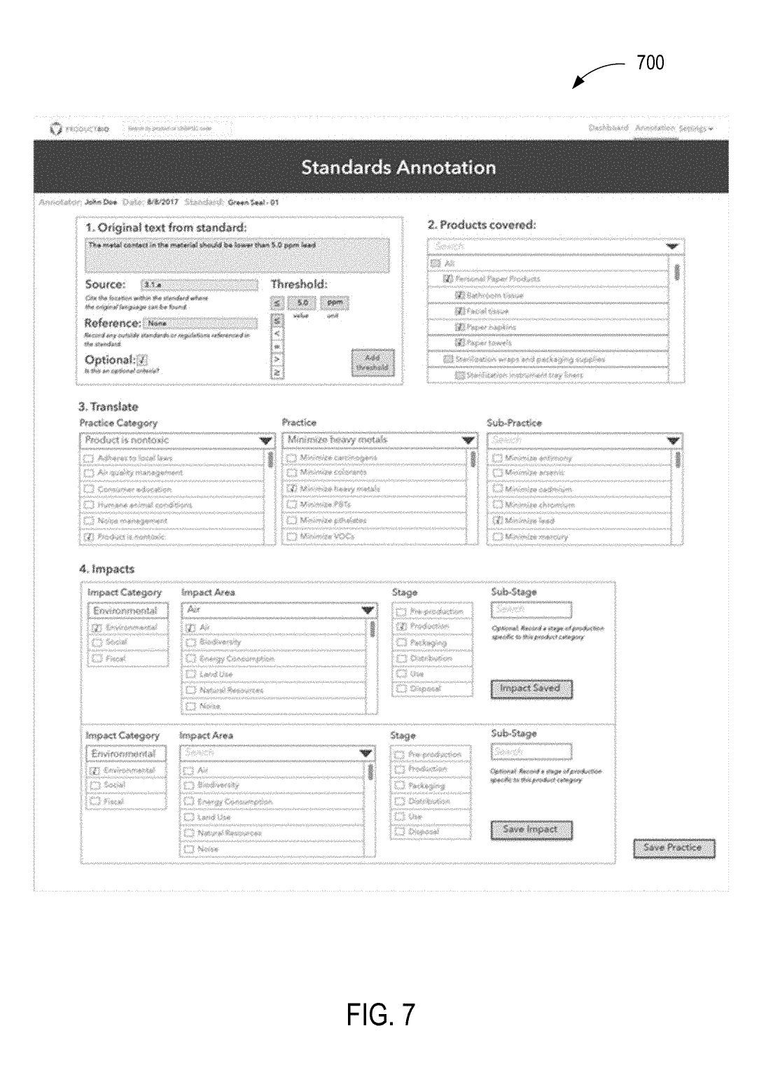

The presentation engine 210 may function to present and/or receive information. For example, the presentation engine 210 may generate a graphical user interface as shown in FIG. 7. In some embodiments, the presentation engine 210 may cooperate with one or more other systems (e.g., augmented sustainability management and analytics system 102) to present information, and/or the presentation engine 210 present information without cooperating with other systems. In some embodiments, the presentation engine 210 may comprise a web browser and/or other application (e.g., a mobile application).

The data annotation engine 212 may function to annotate data (e.g., specification data 240). The data annotation engine 212 may structure existing specifications and criteria (e.g., data 242-248). Various types of raw data pertaining to product information (e.g., data 242-248) can be annotated and converted into structured data. Raw data pertaining to product information can include, as discussed elsewhere herein, product categories, impact areas for each product category, information about how products are made, and the like. Sources of such raw data can include, for example, Ecolabels, MSDS ingredients, vendor catalogue claims, direct manufacturer disclosures, EPP policies, purchase records, and the like.

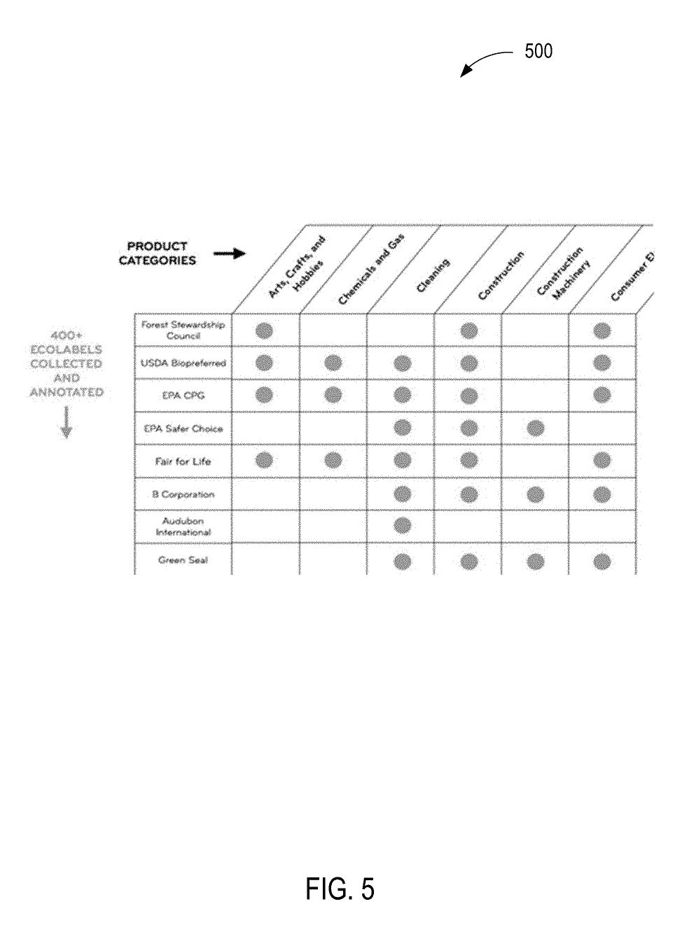

In some embodiments, the data annotation engine 212 functions as an interface to guide the annotation of sustainability standards into a database, automatically mapping practices to product categories and relevant sustainability impacts. A corpus of sustainability standards can be collected, with different sustainability standards providing information about impacts and practices in different product categories. An example chart depicting product categories and labels is shown in FIG. 5.

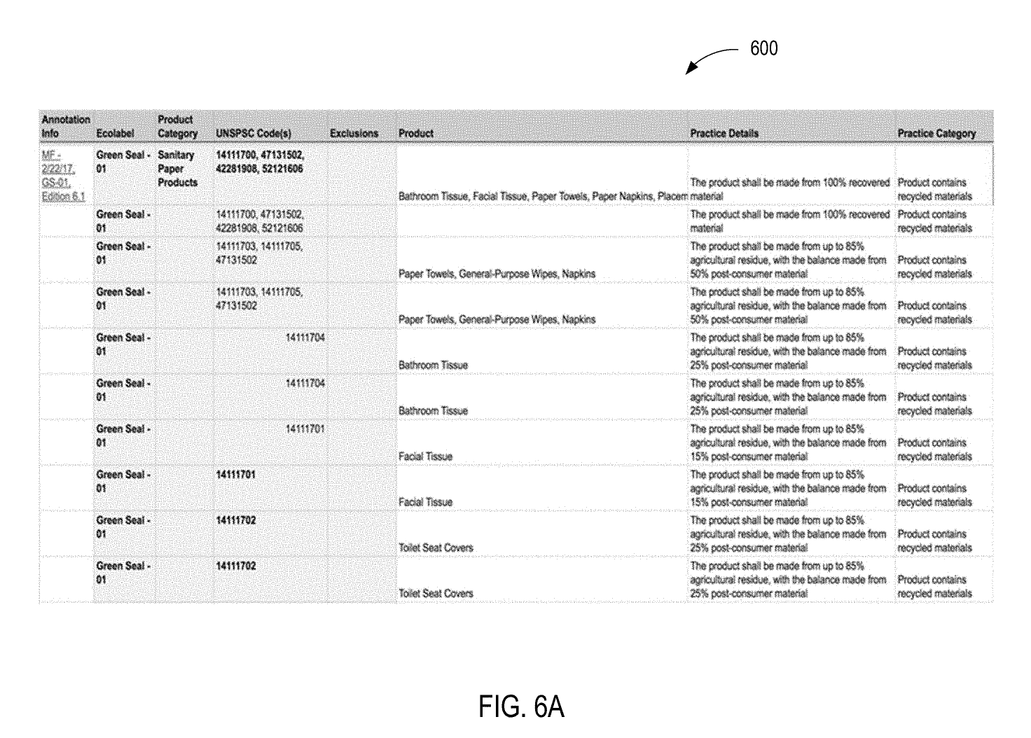

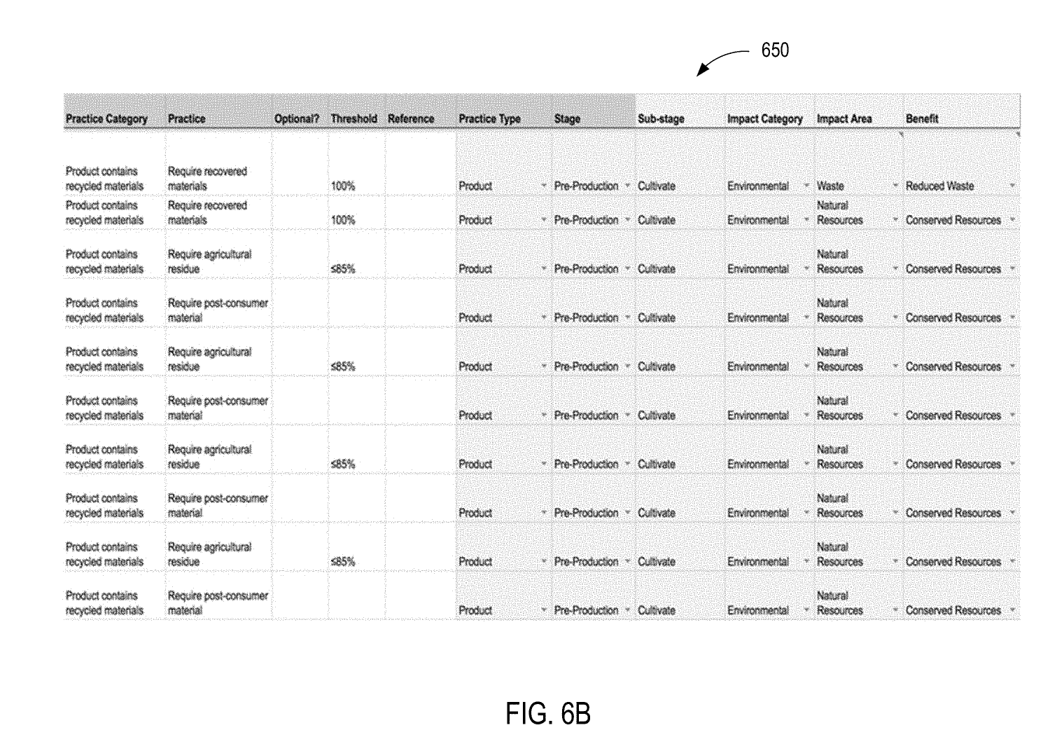

In some embodiments, the data annotation engine 212 (or, “tool” 212) generates one or more interfaces. The interfaces can employ a practice identification code to categorize a hierarchy of practices to draw relationships between key sustainable production practices and sustainable procurement goals. The data annotation engine 212 can enable standards development organizations to annotate their own standards, giving these organizations a better understanding of the benefits gained from their certifications and ensuring accurate mapping within the database. The information gathered in this tool can also be used to help analyze hotspot impact areas of concern for common product categories and cross reference annotations with EPA assessed hotspots to help expand federal sustainable procurement recommendations. An example use case is shown in FIGS. 6A-B.

In some embodiments, the data annotation engine 112 structures standards and ecolabels in a format that is searchable and indexable. The methodology groups practices into Practice Details, Practice Categories and Practices. These may be arranged in a hierarchy allowing users to observe structures and patterns across product categories. Each practice may be mapped on an impact, an impact category, a stage and a sub-stage with benefit giving an explanation to the logic. The annotation matrix can be used to guide the process for each practice found in each standard. FIG. 7 depicts an example annotation tool interface generated by the data annotation engine 112.

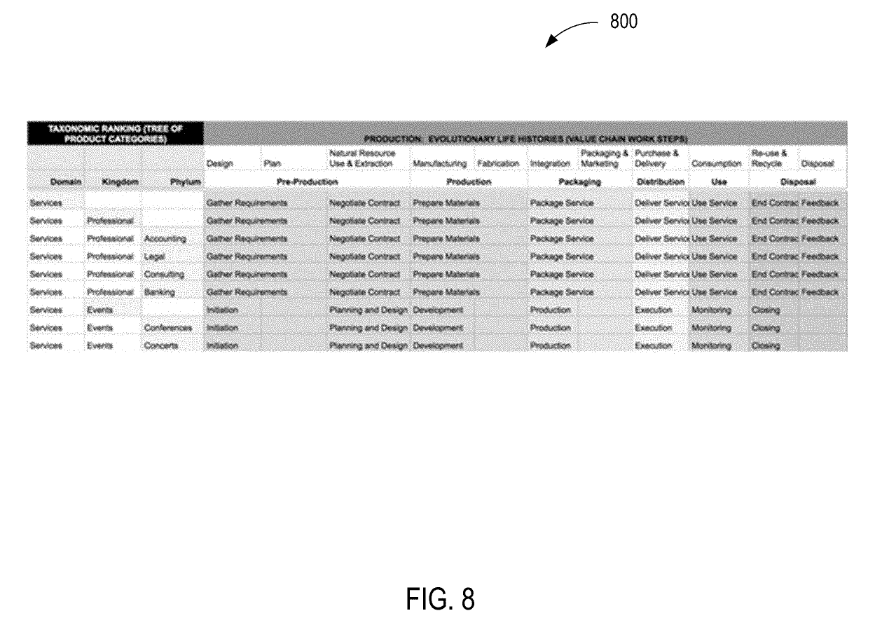

In some embodiments, the data annotation engine 112 functions to map practices/specifications onto an impact area and a workstep using the annotation framework/methodology discussed above. Example worksteps involved in the manufacture of a number of different product categories are shown in FIG. 8. A product's “evolutionary life history” may be understood as a value chain work step in order to form the basis by which “phenotype” informational attributes can be discerned from known “genotype” data sourced from exemplary proxies of data discussed herein (e.g., datasets A, B, C, D, E, discussed above).

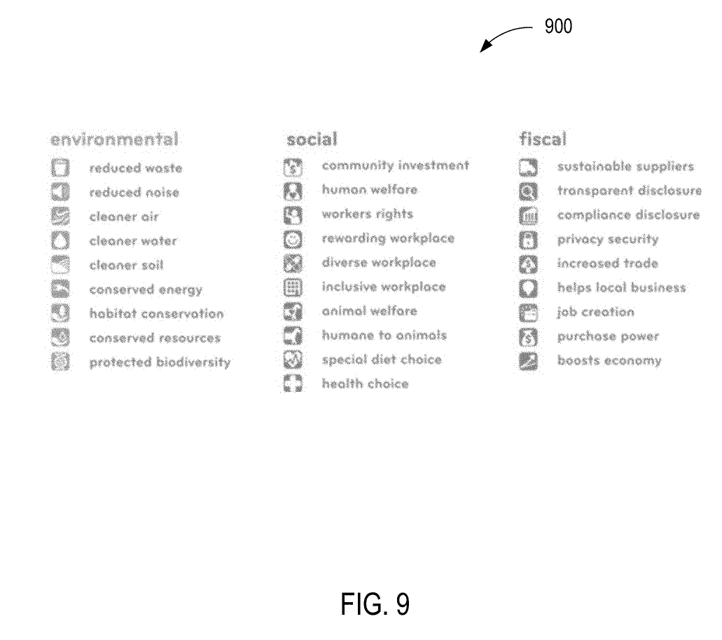

In some embodiments, the data annotation engine 112 annotates various products and/or product categories according to the one or more raw data sources, and a determination can be made as to the various environmental, social, and fiscal impacts associated with production of various products. The data may then be considered structured in a way that associates various products and product categories with one or more impact areas for each production stage of the product/product category (see “example output of annotation process” above). An example list of impact areas is shown in FIG. 9.

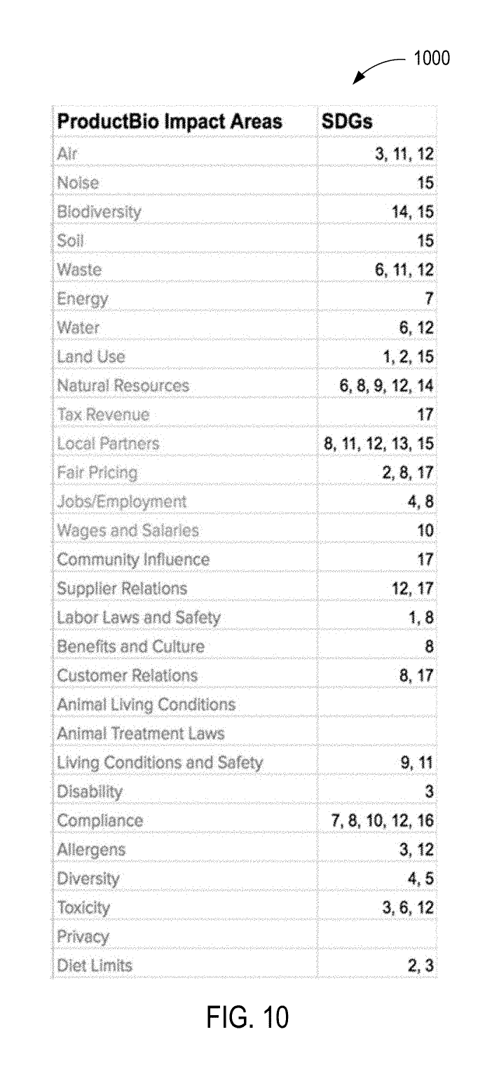

In some embodiments, the data annotation engine 112 maps impact areas onto the United Nations' Sustainable Development Goals (e.g., as shown in FIG. 10).

In some embodiments, annotations may be used determine impact areas at different production stages. The annotation data may also be used to determine various offsetting/beneficial practices associated with a particular product/product category. For example, if a particular product has received certification from a particular ecolabel, it can be assumed/understood that the product has complied with the various requirements set forth by the ecolabel.

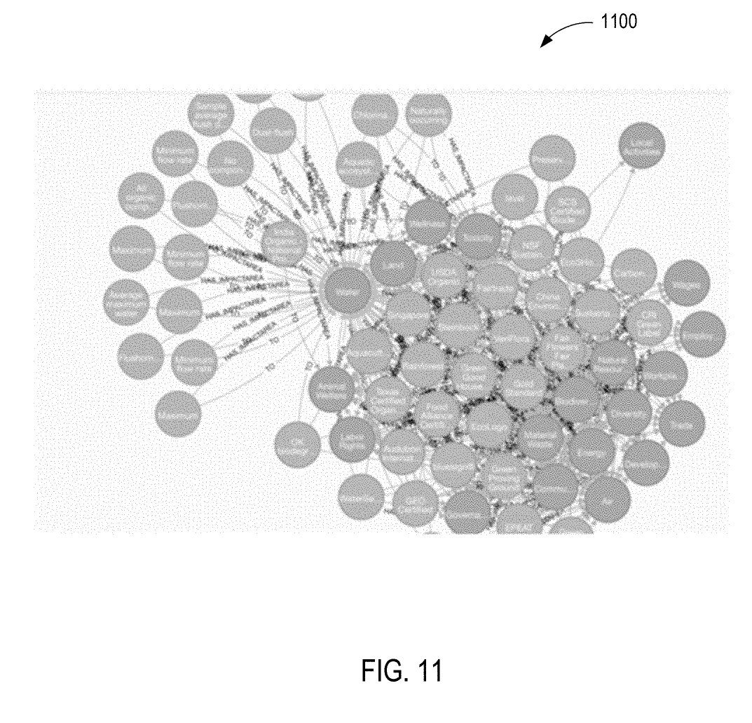

In some embodiments, the annotation structure of the data allows for a deep search tool, which indexes across ecolabels, impacts, stages, product categories and practices. Users can search for local products with specific criteria or products from a specific vendor that are compliant with their EPP. An example graph database generated that may be generated by the date 112 to visualize these results is shown in FIG. 11.

In some embodiments, data structured into a format that is searchable and indexable and that data can be augmented using machine learning methods. Questions, which may be answered, can include:
What patterns and structures underpin the annotated data?
What correlations exist between annotated data and product pricing?
How can the standards data be used to modify market prices to properly account for externalities?

The similarity engine 214 may function to calculate similarity between practices using machine learning and/or statistical methods. In some embodiments, the similarity engine 214 determines that a first product category of a set of product categories is similar to a second product category of the set of product categories. The similarity engine 214 may associated one or more impact areas associated with the second product category with the first product category based on the determining that the first product category is similar to the second product category.

In various embodiments, patterns and latent structures in the datasets underpinning sustainability have been seldom explored and our methods elucidate correlations and patterns between practices/standards and product categories.

Data annotations allow the system to calculate practice similarity scoring, and develop an impact map that may be used to measure similarity between practices within and/or across product categories. With annotated, structured data, the data annotation engine 112 can classify whether two practices for different product categories are similar. For example, one practice in the “production” stage of coffee beans may be to roast the coffee beans. A potentially “similar” practice in the “production” stage of peanuts may be shelling peanuts.

To measure the similarity of two practices, the system 102 can measure the distance between two practices with the following formula:

D_{i,j}=sum_(k=1, . . . ,S×L)|Practice_{i,k}−Practice_{j,k}|.

Here i,j are the practice indexes, S is the total number of worksteps in the annotation matrix (e.g., in the matrices from the previous section, there are six “product stages,” so S=6), L is the number of Impacts in the annotation matrix (e.g., using the example impact areas discussed above, L=29) and k is the index over the grid. The distance between two practices may be a pointwise subtraction of the two grids. An example grid for a particular practice is:

| | S1 | S2 | S3 | S4 |
|---|---|---|---|---|
| I1 | 1 | 0 | 0 | 0 |
| I2 | 0 | 1 | 1 | 0 |
| I3 | 0 | 1 | 0 | 1 |

Where S1, S2, S3, S4 are four example stages (e.g., Pre-Production, Production, Packaging, Distribution) and I1, I2, I3 are three example Impact areas (e.g., cleaner air, cleaner water, cleaner soil). The number “1” is used to indicate that this stage/impact intersection is relevant for the Practice and zero means it is not relevant. The system 102 can subtract all of these grids from each other to build the distance matrix D=D_{i,j}.

Given the distance between two practices, the system 102 can then put a bound on the probability of them being similar. In fact, to be more precise, the system 102 can provide a precise formula for how much they have in common based on the distance between them, which translates into a probability.

The bound may be:

D=D_{i,j}<=(1−X %)*(S×L)

Here, S is the number of annotated stages, L is the number of annotated Impacts, X is the chosen degree of accuracy and D is the distance between two practices. Therefore for a particular value of S,L and X if D is equal to this value then the system 102 can conclude that two practices are X % similar. An exemplary value of X may be 90% or greater. The value of X can be tuned as additional data is added. The value can be optimally tuned by testing over the whole dataset and working with a test set to confirm the effectiveness of the value.

Provided below are two simple examples of comparing two practices for similarity:

### Similar Practice Example:

90% Confidence
S = 4
L = 4
D <= (1-0.9)*(4*4)
D <= (1.6)
Practice 1 Stages/Impact Matrix:

| Stage | | | |
|---|---|---|---|
| S1 | S2 | S3 | S4 |

Impact

| | | | | |
|---|---|---|---|---|
| I1 | 1 | 0 | 0 | 1 |
| I2 | 0 | 1 | 0 | 0 |
| I3 | 1 | 1 | 1 | 0 |
| I4 | 0 | 0 | 0 | 0 |

Practice 2 Stages/Impact Matrix:

| Stage | | | |
|---|---|---|---|
| S1 | S2 | S3 | S4 |

Impact

| | | | | |
|---|---|---|---|---|
| I1 | 1 | 0 | 0 | 1 |
| I2 | 0 | 1 | 1 | 0 |
| I3 | 1 | 1 | 1 | 0 |
| I4 | 0 | 0 | 0 | 0 |

$\begin{matrix}D\_ \{ 1 , 2 \} = \vert Difference row 1 \vert + \vert Difference row 2 \vert + \\ \vert Difference row 3 \vert + \vert Difference row 4 \vert \\ = 0 + 1 + 0 + 0 \\ = 1 <= 1.6\end{matrix}$

Therefore, these two practices are 90% similar.

### Dissimilar Practice Example:

90% Confidence
S = 4
L = 4
D <= (1-0.9)*(4*4)
D <= (1.6)
Practice 1 Stages/Impact Matrix:

| Stage | | | |
|---|---|---|---|
| S1 | S2 | S3 | S4 |

Impact

| | | | | |
|---|---|---|---|---|
| I1 | 1 | 0 | 1 | 1 |
| I2 | 0 | 1 | 0 | 0 |
| I3 | 1 | 1 | 1 | 0 |
| I4 | 0 | 0 | 0 | 0 |

Practice 2 Stages/Impact Matrix:

| Stage | | | |
|---|---|---|---|
| S1 | S2 | S3 | S4 |

Impact

| | | | | |
|---|---|---|---|---|
| I1 | 1 | 0 | 0 | 1 |
| I2 | 0 | 0 | 1 | 0 |
| I3 | 1 | 1 | 0 | 0 |
| I4 | 1 | 1 | 0 | 0 |

$\begin{matrix}D\_ \{ 1 , 2 \} = \vert Diff row 1 \vert + \vert Diff row 2 \vert + \vert Diff row 3 \vert + \vert Diff row 4 \vert \\ = 1 + 1 + 1 + 2 \\ = 5 > 1.6\end{matrix}$

Therefore these two practices are not 90% similar.

In some embodiments, by comparing a set of practices within a dataset, all “similar” practices within a dataset can be identified. As will be described in greater detail elsewhere herein (e.g., with reference to the sustainability inference engine 216), identification of similar practices can be used to make inferences and fill in the gaps in trees, for example, for product categories that do not have standards/claims data available, and/or for which some of this data is not available.

The sustainability inference engine 216 may function to utilize machine learning to infer product sustainability from phylogenetic methods to fill in unknown product category rules, liability impact areas and also environmental product declarations and benefit offset opportunities with relationship trees (e.g., three relationship tress) using phylogenetic methodology. Phylogenetic methods can be used by our platform to create a “work” tree where shared supply chain practices form the relationships between categories and thus allow for inferences to be made about shared liabilities.

Generally, in evolution, organisms are linked together by a pattern of descent with modification as they evolve. Supply chains are very different from living organisms, but they still have a history of shared descent as they are formed from the same base ingredients, made with the same factories necessitating similar work steps, and carry that history in their end result which are often touted as marketing attributes about the products contained in supplier claims about product specifications.

By studying supply chain practice and impact signatures found in product sustainability certifications and material disclosures, the present disclosure combines techniques in data science, applied biology and archeology to build a family tree of all products based on supply chain data. Evolutionary trees are compiled which look at “how products are made” and find signatures that are comparable to product DNA sequences.

Sequencing the product genome also studies relationships between categories of manufacturing and how they are connected together, thus also revealing which portions of product supply chains share environmental, social, and fiscal impact liabilities of concern. Also disclosed herein is the added capability of predicting what something should cost, what sustainability should mean, and how the product is likely to perform to its category's specifications. The present disclosure allows for production information that is predictive (cost, quality, sustainability) rather than descriptive (scraped data).

Various methods disclosed herein create phylogenetic trees to “sequence the product genome” in such a way that connects product supply chains leveraging known relationship variables: The branches of the tree serve to provide information about products' shared evolutionary life histories in the form of their supply chains.

Products from ecolabel-provided product lists can be studied. The work practices and resultant impacts along a supply chain as specified by these third party certifiers can be annotated with measurable thresholds of environmental, social and fiscal outcomes from data coming directly from the certifiers. Once the families of practices are identified using their supply chain impact maps, their similarities, differences, and evolution can be studied with the help of historical annotations.

Products are manufactured. Two products (e.g., coffee, chocolate) with the same work steps (e.g., cultivation, harvest) are likely to have the same base ingredients (e.g., beans) and share supply chain liabilities (e.g., nitrogen run-off into the soil as a result of practices used for cultivation and harvest).

Described below are example mechanisms of inference of the “work” tree using comparative phylogenetic methods.

Supply Chain Phylogeny: Reconstructing the Work of all Products with an Evolutionary Tree

By mapping family trees for the supply chains of products, a new approach to balancing sustainability budgets can be developed. Product supply chains may be charted in the same way family tree of biological species. Using data translated from 450 ecolabels across 500,000 unique products, the system observed their ingredients/chemical makeup, their age, and other factors to plot them on a supply chain tree of life.

Products can be plotted on branches of the tree, with a few miscellaneous ones that didn't fit with the others. The system can tell which products are related based, for example, on their ingredients, work practices, corporate ownerships, or other features, almost like DNA. For example, if they were made of the same ingredients, this may be indicative that their impact areas and work steps would be similar.
Data System Creates (Inferred)
Who made it? (List as “in-house” or from a supplier)
What was done? (The work step description of the supply chain stage) ( . . . or what was it made of, i.e. ingredients)
When was it done (date product introduced . . . or discontinued)
Where was it done? (location)
How was it done (sustainability practices)
Why was it done this way? (impact descriptions of the benefit)

Data System Scrapes (Direct):
When: “Release date” (date)
What: “Type” from the category (species)
Where: “Market: Location Sold/Made” (environment)
How: “Key Features” (features)
What: “Product Line” from the brand (lineage in phylogeny)

In some embodiments, entire product lines can be mapped and organized in a way that is meaningful. In one embodiment, the FigTree taxonomy methodology can be used to map and organize products.

In some embodiments, this information is used to map out product taxonomies and organization.

An example of a product information request template for vendor partners may be as follows:

a) Tell the system about this product:
Release date: 2008
Type: Coffee-->Ground Coffee
Geography—where made/Customer Market—where consumed: Made in Honduras, Sales highest in California
Features: Bold Dry Freeze
Product Line: Part of Starbucks' Dark Roast Line, descendent from Original Roast

Using the structured data gathered above, various trees can be built, including, for example, a work tree:
Given similarities between practices the system can infer additional practices onto products. This process involves first identifying a threshold number of similar practices across Product Categories and then filling in the blanks if two conditions are met: (1) There must exist a number of similar practices between the two product categories; and (2) The similar practices fall within a threshold curve which seeks to ensure it is easier to infer down the supply chain rather than up, i.e., it is easier to make inferences about practices that take place earlier in the production process, and more difficult to make inferences about practices that take place later in the production process.
The determination of whether two practices are similar follows the method as described above (e.g., with reference to similarity engine 214).
The system can measure the number of similar practices over the full product category list. This provides the system with statistics regarding the average number of similar practices between categories at each stage.
If two product categories have greater than the average number of similar practices+one standard deviation, the system can deem the product categories to be similar and inference can occur.
A threshold curve makes it easier to infer down the supply chain rather than up. This is owing to the tree-like nature of the product genome. The threshold curve simply says the system can infer downwards if the practices are similar to a lower degree of certainty than the inferring upwards, which requires a higher degree of certainty.
The level of certainty needed to infer practices on a product category is tuned based on the annotated data and can be adjusted as the system input and aggregate more sources. In certain embodiments, levels of certainty can be chosen to ensure that based on controlled testing, the system may be able to predict correctly over 90% of the time

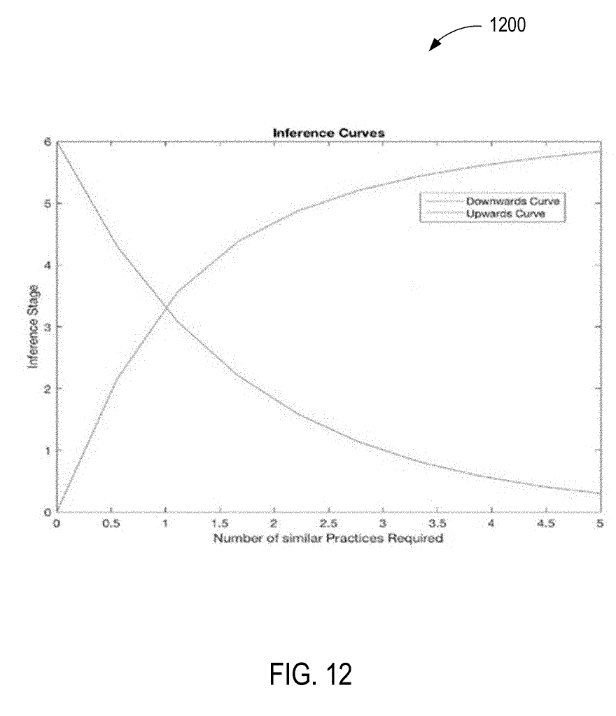

The sustainability inference engine 216 may function to generate both an upwards and downwards threshold curve. An example is shown in FIG. 12. The coefficients of the curves are fit based on the data. See the example below for the relevant Equations and an exposition of how the curves are fit and how they practically work:

Concave up=upwards inference

Concave down=downwards inference

The x-axis represents the number of similar practices that are required to make an inference of practices from one product category to another, and the y-axis represents the number of stages between the stage for which an inference is being made and the nearest stage at which a similar practice exists. For a more detailed understanding of how these curves can be used to make inferences of practices from one product category to another, consider the following example scenarios.

Supposed that it is determined that the average number of similarities between product categories over the whole dataset=2.3 and the standard deviation=0.6.

Now consider the following two product categories:

| | Product Category 1 | | Product Category 2 |
|---|---|---|---|
| Stage 1 | Practice 1 | similar to | Practice 7 |
| Stage 2 | Practice 2 | similar to | Practice 8 |
| Stage 3 | Practice 3 | | |
| Stage 4 | Practice 4 | | Practice 9 |
| Stage 5 | Practice 5 | | |
| Stage 6 | Practice 6 | similar to | Practice 10 |

In Stage 1, Practice 1 of Product Category 1 has been determined to be similar to Practice 7 of Product Category 2 (based on the similarity analysis, discussed above). In Stage 2, Practice 2 of Product Category 1 has been determined to be similar to Practice 8 of Product Category 2, and in Stage 6, Practice 6 of Product Category 1 has been determined to be similar to Practice 10 of Product Category 2.

As such, these two product categories have three similar practices. Therefore, they are over the mean+standard deviation=2.3+0.6=2.9. Thus, the system can deem these two product categories to be similar. In certain embodiments, practice inferences can be made between product categories that are determined to be similar. As such, in this example, certain practices can be inferred from Product Category 1 onto Product Category 2 (or vice versa) based on the determination that the two product categories are similar.

In order to make an inference of practices from one product category to another, the system may inspect the fitted threshold curves. First, the system may consider an “upward inference.” In this example scenario, the nearest stage from which the system can infer “upwards” to Stage 3 is Stage 2. This is a jump of 1 stage. Based on the threshold curves depicted above, in order to infer upwards “1” stage (“upwards curve” at y=1), approximately 3.3 similar practices are required. Since there are three similar stages, this inference cannot be made. However, inferring downwards from stage 6 to stage 3, a leap of 3 stages (“downwards curve” at y=3) requires the number of similar practices to be at least 1.25. Since there are three similar practices, this inference can be made. Therefore, the system can make that inference and the gap at Stage 3 in Product Category 2 can be filled in using Practice 3 from Product Category 1. As discussed above, the threshold curves make it significantly easier to infer downwards down the production chain than it is to infer upwards.

In one embodiment, the equation for the example upwards curve is:

stage=c₁*tan̂{−1}(a₁*p),

where c₁,a₁ are fitted coefficients and p, the x-axis value, is the number of similar practices required between the product categories.
c₁—sets the height of the curve and, in various embodiments, can be tuned to ensure that the maximum value is the max number of stages (e.g., 6).
a₁—sets the gradient of the curve. This can be tuned based on the observed statistics of the number of similar practices between product categories. For example, this figure can be tuned to ensure that inference across product categories is correct 90% of the time (e.g., based on a standard test/train split approach).
The y-axis, i.e., “stage,” represents the various production stages in a production process (e.g., (1) pre-production, (2) production, (3) packaging, (4) distribution, (5) consumption, (6) disposal) and how many stages one is attempting to traverse with an inference. For example, making an inference from stage 1 to stage 3 would require looking at “y=2,” because the difference in stages is 2.

In various embodiments, the equation for the downwards curve is:

stage=c₂*exp(−a₂*p).

Again, c₂,a₂ are fitted coefficients.
c₂—should be set to the number of stages (in our annotation this is 6).
a₂—similar to a₁ above, this sets the gradient of the curve. A smaller value of a₂ gives a shallower gradient. Again this will be tuned to ensure the downwards inference is correct 90% of the time based on a test/train split

The benefit efficiency scoring engine 218 may function to determine benefit efficiency scores 250. In some embodiments, the benefit efficiency scoring engine 218 performs sustainability comparisons quantitative in determining product recommendations and also to allow for quantitative comparisons between products. In various embodiments, the method by which such quantification is made can be specific within environmental, social, and economic factors at the impact level, but can also be combined at the product category level.

In some embodiments, effective spend is allocated across product categories using a benefit efficiency score. Where does it make sense to spend an extra dollar in terms of gaining green products. These concepts are described in greater detail below, but an overview of an embodiment is as follows:

In some embodiments, the system gathers and/or annotates all relevant standards for typical product categories. The annotated data identifies the impacts (also referred to as liabilities) (e.g., environmental, fiscal, social) for each product category. For each product in each product category, the system can use environmental product declarations to determine offsets for the impacts/liabilities (i.e., actions that can be taken to offset the negative impacts). The system can calculate a benefit efficiency score for each product based on the impacts/liabilities and offsets. The system can calculate average performance for all products in each product category and set a threshold for product recommendation. The system can infer the average benefit per dollar spent in each product category.

Annotation of various sources can provide the system and/or users with an idea of impacts and offsets for various product categories. Then, identification of similar practices and similar products can allow the system to infer practices for any product categories for which information is lacking, providing a fuller picture of impacts and offsets for each product category.

### Calculating Product Benefit Efficiencies

The concept of offsetting a particular impact or liability allows the system to calculate a product benefit efficiency score. From the unified database of annotated specifications, the system knows the areas of liability (i.e., impact) for each product category. This creates the potential for different products to offset these liabilities to a different extent based on both the number of impact areas their specifications address and the quality of the practices in their worksteps.

To begin, three simple examples are introduced demonstrating how a product benefit efficiency score can be calculated for products in three cases:
1) A simplest case, in which all impacts and all offsets are weighted equally
2) A case in which impacts are weighted differently, but all practices offsetting a particular impact (i.e., offsets) are weighted equally
3) A case in which different practices have different weights

Case 1:

In this simplest case, the product benefit efficiency score for a given product can be calculated as the number of offsets for a particular product divided by the total number of impact areas (or liabilities) for the product's product category.

Consider the following example. Product Category A has 4 impact areas of liability: water, air, soil, and fair wages. Product 1 in Product Category A has offsets for 1 of the 4 (e.g., the manufacturer of product 1 provides his employees with fair wages, thereby offsetting the “fair wages” impact.) In this case, Product 1's product benefit efficiency score would be equal to:

(# of offsets)/(# of liabilities/impact areas)=¼=25%.

If Product 1 had employed offsets for, for example, the water and air impact areas, Product 1's product benefit efficiency score would be 2/4=50%.

Case 2:

In this second case, various impact areas are assigned weights based on their importance for a particular product category. For example, a first product category may have a significant impact on water, resulting in a higher weight for that impact area for the first product category, whereas a second product category may have an impact on water, but to a much lesser degree, resulting in a lower weight for the “water” impact area for the second product category. In various embodiments, impact areas can be assigned with weights indicative of their importance to a particular product category, and product benefit efficiency scores can be weighted based on impact area weights.

In various embodiments, impact areas for a product category can be grouped into one of a plurality of “weight categories.” Which weight category a particular impact area should be assigned to can be determined by first calculating a weight value for each impact area for the product category:

Weight value=Number of specifications referencing impact area/Total number of specifications referencing product category

In other words, the significance of a particular impact area to a particular product category, as indicated by weight value, can be quantified by dividing the number of specifications that reference the particular impact area divided by the total number of specification referencing the particular product category. For example, if 100 specifications discuss the product category “paper,” and 85 of the specifications discuss the impact of paper on generating waste, then the weight value of the “waste” impact area on the “paper” product category equals 85/100=85%.

Once weight values have been calculated, products can be bucketed into various “weight categories” based on the weight values. For example, there may be a “high” weight category, a “medium” weight category, and a “low” weight category. In one example embodiments, weight values in the bottom third (<33%) for a product category can be classified as “low,” weight values in the top third (>66%) can be classified as “high,” and weight values in the middle third (33%-66%) can be classified as “medium.” Each class or bucket can be assigned a category value indicative of importance, e.g., high=3, medium=2, low=1. Product benefit efficiency scores can then be calculated based, at least in part, on the category values.

Consider the following example:

Product Category A has 4 impact areas of liability: water, air, soil, and fair wages. In this example, impact areas can be categorized into one of three weight categories: high liability, medium liability, or low liability. Product Category A's 4 impact areas and corresponding weight categories are as follows:

Water—high liability

Air—medium liability

Soil—low liability

Fair Wages—low liability

Given the liabilities/impact areas for the product category, the system now look at the offsetting practices associated with a particular product. For example, Product 1 in Product Category A has specifications attached offsetting the following impact areas:

Water

Air

Soil

The product benefit efficiency score is thus:

$$Product benefit efficiency score = weighted offset liabilities / weighted total liabilities = ( water + air + soil ) / ( water + air + soil + fair wages ) = ( 3 + 2 + 1 ) / ( 3 + 2 + 1 + 1 ) = 6 / 7 = 86 \%$$

Case 3:

The distinction in this example embodiment, from that discussed above in Case 2, is simply that various practices associated with the offsets are given a percentage score. This scales total benefit efficiency depending on which practices the product has associated with it. For example, there may be five ways (or practices) to offset the “water” impact area, and certain practices may be considered more effective than others, or multiple practices may be required to fully offset the impact area. As such, different practices may be categorized based on an offset weight indicative of how effective such practices are at offsetting an impact area.

Practices can be bucketed into high, medium and low offset weight categories in a similar fashion to the liabilities/impact areas. Classifications of practices can be based on and/or indicative of how effective a practice is at offsetting an impact area. For example, a high offset value and/or offset weight category indicates that a practice is highly effective at offsetting an impact area, a medium offset value and/or offset weight category indicates that a practice is somewhat effective at offsetting an impact area, and a low offset value and/or offset weight category indicates that a practice is marginally effective at offsetting an impact area. Based on their significance, the system then normalize and grade each practice based on the range of significance scores. These scores then scale the offset percentage by either 100%, 66%, 33% depending on whether the practice is deemed high, medium or low.

Assume from the example of Case 2 that Product 1 of Product Category A has the following offsets:

Water—high offset

Air—medium offset

Soil—low offset

It's product benefit efficiency score can be calculated as follows:

$$Product benefit efficiency = weighted offset liabilities / weighted total liabilities = ( water + air + soil ) / ( water + air + soil + fair wages ) = ( 3 * 100 \% + 2 * 66 \% + 1 * 33 \% ) / ( 3 + 2 + 1 + 1 ) = 66 \%$$

Case 4:

The distinction in this example embodiment, from that discussed above in Case 2, is simply that various practices associated with the offsets are given a percentage score. This scales total benefit efficiency depending on which practices the product has associated with it. For example, there may be five ways (or practices) to offset the “water” impact area, and certain practices may be considered more effective than others, or multiple practices may be required to fully offset the impact area. As such, different practices may be categorized based on an offset weight indicative of how effective such practices are at offsetting an impact area.

Practices can be bucketed into high, medium and low offset weight categories in a similar fashion to the liabilities/impact areas. Classifications of practices can be based on and/or indicative of how effective a practice is at offsetting an impact area. For example, a high offset value and/or offset weight category indicates that a practice is highly effective at offsetting an impact area, a medium offset value and/or offset weight category indicates that a practice is somewhat effective at offsetting an impact area, and a low offset value and/or offset weight category indicates that a practice is marginally effective at offsetting an impact area. Based on their significance, the system then normalize and grade each practice based on the range of significance scores. These scores then scale the offset percentage by either 100%, 66%, 33% depending on whether the practice is deemed high, medium or low.

Assume from the example of Case 2 that Product 1 of Product Category A has the following offsets:

Water—high offset

Air—medium offset

Soil—low offset

The product benefit efficiency score can be calculated as follows:

$$Product benefit efficiency = weighted offset liabilities / weighted total liabilities = ( water + air + soil ) / ( water + air + soil + fair wages ) = ( 3 * 100 \% + 2 * 66 \% + 1 * 33 \% ) / ( 3 + 2 + 1 + 1 ) = 66 \%$$

### Setting Product Benefit Efficiency Thresholds

Within a particular product category, the system determine green product thresholds over which products are deemed “green” or “best in class.” In certain embodiments, products that satisfy a green product threshold may quality to be included as a product recommendation. Within a particular product category, the green product threshold can be calculated in the following way:
The top n products are selected within a product category based on product benefit efficiency scores. n is calculated according to the following formula: n=max(number of products which have product benefit efficiency scores greater than the mean product benefit efficiency score within the product category+one standard deviation, 10). The top n products are selected as recommended products, or green products, within the product category. By using this function, the system can ensure that at least 10 products are recommended within each product category. The idea here is to ensure that at least 10 products are recommended through the system at any one time.
The green product threshold can be equal to the lowest product benefit efficiency score of the top n products within the product category.

In this way, product benefit efficiency scores are used to calculate a green product threshold for each product category. A product with a product benefit efficiency score above the green product threshold is considered green, and may quality for recommendation to a user. This ensures that only the “best” products are deemed the most sustainable with the performance being contingent on the expected values in each product category

### Policy Benefit Efficiency Score (Environmentally Preferable Purchasing Policies)

Buy-side organizations will often have environmentally preferably purchasing policies (EPP's) which identify the organization's policies with regard to sustainable purchasing practices. For example, an organization's EPP might specify that the organization will only purchase recycled paper, or will only purchase fair trade coffee. A policy benefit efficiency score can be calculated for an organization's EPP indicative of how well the policy addresses sustainability issues. In one embodiment, the policy benefit efficiency score can be calculated as follows:
Policy Benefit Efficiency score=weighted number of liabilities (i.e., impact areas) offset by the policy/(weighted total number of liabilities for all product categories discussed in the policy)

It should be appreciated that the score can also be calculated in an unweighted fashion (all offsets and liabilities having the same value). It should also be appreciated that different weighting methodologies can be used, such as those described above with respect to product benefit efficiency scores. As discussed previously, weights for impact areas/liabilities can, in certain embodiments, correspond to high, medium, low and can be calculated according to various methodologies, such as the various embodiments described above with respect to product benefit efficiency scores.

### Example

Assume that a policy contains practice A and practice B for coffee and chocolate, respectively, and these are the only two product categories in an organization's purchase orders. Then the system can calculate the policy benefit efficiency score as follows:

Policy Benefit Efficiency Score=(Weighted Impacts offset by Practice A+Weighted Impacts Offset by Practice B)/(total weighted impacts for coffee+total weighted impacts for chocolate)

The true value engine 220 may function to calculate true value based on benefit efficiency scores. There is a tendency to believe that sustainability and cost go together, but the system can shows this may not be the case. This analysis hasn't been done by the manufacturers even with value stream mapping or value engineering. The concept of “True Value Engineering” (TVE) may show where true value (not just product cost savings or utility benefits but also sustainability benefits realized through optimal practices without necessarily increasing prices paid, can be captured for the customer.

Being able to locate products that are both cheaper and better for the environment, and to break this hypothetical cost vs. sustainability trade-off, is significant because it enables two functionalities:
finding the “true north” of what the standard ought to be vs. which ones are simply low cost.
Finding places where you can reduce costs while also improving environmental or social performance.

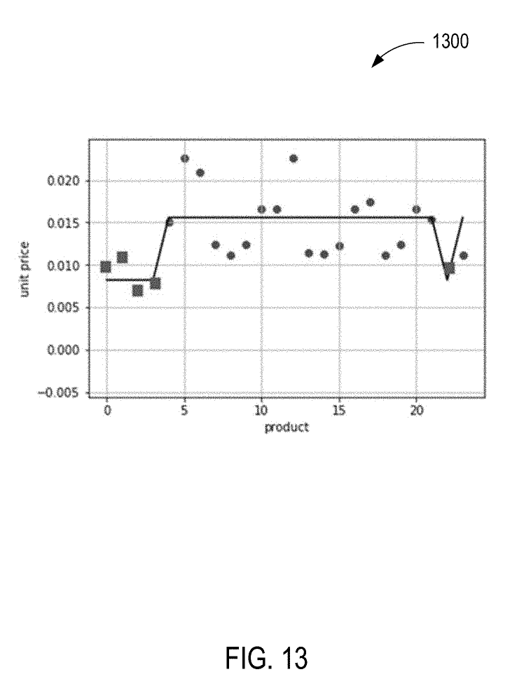

This may eliminate the argument that the basic assumption is that it is more costly to do the right thing for the environment. FIG. 13. illustrates an example wherein it is not necessarily true and that there is a positive correlation. FIG. 13 indicates the unit prices for 20 paper products from Office Depot. Green dots indicate a product with an ecolabel and red squares do not. As can be seen in this simple example, the ecolabel on average costs more but in certain instances it isn't necessarily the case.

For procurement organizations to be fiscally sustainable when justifying the changing procurement decisions en-mass from incumbent products to another product alternative, they must generally make the case that it is not just good for the environment but for the company/city budget too. It's possible to hit sustainability targets, but what it actually means in terms of procurement breakdowns and cost differentials is discerned for the user. This is enabled by calculating average deltas in pricing information of product attributes and impact offsets.

Given the product benefit efficiency score the system can begin the calculation of True Value (also referred to as “True Cost”). The present disclosure provides for ways to communicate with clients using the language that they work with, i.e. price. In particular, the present disclosure can, in various embodiments, price a product based on its True Value or True Cost, i.e., its financial cost adjusted for environmental/social/fiscal impacts per product category.

True Value Engineering (TVE) attempts to incorporate and account for the external impacts on the environment/society in the market price of a product. The system can adjust the observed market price by the benefit efficiency score to indicate to a procurement officer the “True Cost” of the product. The example below illustrates this adjustment.

### Example

Consider three Paper products, Paper A, Paper B, Paper C (all within the “paper” product category). Paper A has a product benefit efficiency score of 80% and costs $10, while Paper B has a product benefit efficiency score of 30% and costs $3, and Paper C has a product benefit efficiency score of 40% and costs $8:

| PAPER A | to PAPER B | PAPER C |
|---|---|---|
| 80% efficiency | 50% | 40% |
| $10 | $5 | $8 |

True cost can be calculate by dividing a product's actual cost by its product benefit efficiency score. As such, Paper A's True Cost is $10/0.8=True Cost $12.5. Paper B's True Cost is $5/0.5=$10, and Paper C's True Cost is $8/0.4=$20.

Therefore, although Paper C is cheaper on the market than Paper A, by factoring in the inefficiencies from its poor sustainability performance, Paper C's “True Cost” is demonstrated to be significantly more than the Trust Cost of Paper A. As such, Paper A would be preferable over Paper C when considering both cost and sustainability impact considerations. However, Paper B, which is significantly cheaper than Paper A but is only marginally less efficient from a sustainability standpoint, has a True Cost that is lower than Paper A.

These concepts can be incorporated into a decision making framework of the system which may ensure that the user knows that even though the market prices between two products may be large the true costs may be small, thus indicating that paying the extra market price is incentivized because of the gains in externalities.

The benefit inference engine 222 may function to infer various measures. Measures may include Green Spend Potential (defined by a Green Spend Potential Score) when referring to the potential performance of policies in harnessing spend or Green Spend Performance (defined by a Green Spend Efficiency Score) when referring to the actual spend performance based on historical purchase order records of an organization's spend on capital and operational expenditure goods and services.

When a sell-side vendor or manufacturer produces a good or service that is good at creating value for a buyer's cost and sustainability needs, they become effective at generating revenue. The common language of Benefit Efficiencies can be talked about in many contexts by stakeholder groups. Example stakeholder groups may include:

| Reportable Metric | Defined by | Calculated from | Used when |
|---|---|---|---|
| Green Spend | Green Spend | (EPP benefits/Truth | Speaking about the |
| Potential | Potential Score | North Liabilities) * | potential performance of |
| | | 100% | EPP policies in harnessing |
| | | | spend |
| Green Spend | Green Spend | (Dollar weighted | Speaking about the actual |
| Performance | Efficiency Score | number of Green | spend performance based |
| | | products/Total | on historical purchase order |
| | | Dollar value of | records of an organization's |
| | | Products)*100% | spend on capital and |
| | | | operational expenditure |
| | | | goods and services. |
| Green Revenue | Green Revenue | (Number of Products | Evaluating the benefit of |
| Potential | Potential Score | Compliant with | product offerings in vendor |
| | | EPP/Total Number | catalogues or supplier |
| | | of Products)*100% | service offerings in RFI and |
| | | | RFP responses. |
| Green Revenue | Green Revenue | (Total Revenue of | Evaluating the benefits |
| Performance | Efficiency Score | Green Products Sold/ | captured in sales order |
| | | Total Revenue of all | receipts generated from |
| | | products sold)*100% | transactions made through |
| | | | e-procurement systems, or |
| | | | bids and contracts won. |

Given product benefit efficiency scores and pricing data for different product categories, the system can calculate the monetary value of 1% in product benefit efficiency or, more generally, how much it costs to be green. With this metric defined, the system can communicate to procurement officers how an increase in $1 or a decrease in $1 translates into compliance with their purchasing policy or recommended practices.

In this section, benefit per dollar is represented in two ways both as an improvement in product benefit efficiency score and as an improvement in a new metric: green spend efficiency score, which measures, of an organization's total spend, what is the percentage that is “green”. Although the examples presented below will define a “green” product as one that satisfies the product benefit efficiency score thresholds, as described in greater detail above, it should be understood that “green” can be understood to mean any level of compliance, for example, with a structured data database, a user's EPP, a peer's comparison, etc.

### Green Spend Efficiency (Purchase Orders)

Green spend efficiency is a measure of how well an organization is doing in actually spending money on “green” (e.g., sustainable and/or recommended) products. In certain embodiments, a “green” product can be one that satisfies a product benefit efficiency score threshold, such as those discussed above (e.g., in reference to benefit efficiency scoring engine 222). In other embodiments, a “green” product may be one that satisfies an organization's EPP, or one that satisfies an industry norm or requirement, peer organization averages, and the like. Green spend efficiency may be calculated using the following equation:

Green Spend Efficiency=Number of green products purchased*each product's spend/total spend of all products purchased

### Example

Total spend=$10 million

Purchased $7 million of Product A and $3 million of Product B

Ecolabels attached to Product A offset 50% of the weighted liabilities/impact areas in the user's policy, giving it a product benefit efficiency score of 50% (NOTE that in this example, the product is being compared to impact areas identified in the user's policy, such that this product benefit efficiency score is indicative of the product's compliance with the policy, rather than the product's efficacy with regard to all impact areas for the product area). For this example, the system can assume that the product benefit efficiency score threshold is 40%, such that this product is above the threshold and qualifies as a “green” product.

Similarly for Product B the product benefit efficiency score is 25%, which is below the threshold. As such, Product B does not qualify as a “green” product.

$$Green Spend Efficiency = spend on green products / total spend = ( \$7 million ) / \$10 million = 70 \%$$

### Benefit Per Dollar Spent

In order to provide recommendations as to how organizations can best allocate additional spend, various “benefit per dollar” metrics can be determined.

### Product Benefit Efficiency Improvement Per Dollar Spent

In some embodiments, all products within a particular product category can be plotted on a graph based on price and benefit efficiency. In certain embodiments, if multiple products have the same product benefit efficiency score, the product with the lowest price among that group can be plotted while the rest are removed from the plot. In order to calculate an average “product benefit efficiency improvement per dollar” measure for the entire product category, a line can be fitted to the data. For example, if a line fitted to product category data yields a slope of 2, this can be understood to mean that within the product category, additional spend of $1 on a product will, on average, result in an increase of 2% in product benefit efficiency score. As used in this paper, this rate may be referred to as the “product category average improvement.”

In various embodiments, product recommendations can be made based on product category average improvement. For example, consider an example scenario in which an organization is spending $2 for one pound of a particular coffee product, Coffee A, which has a product benefit efficiency score of 50%. Furthermore, assume that the product category average improvement for coffee is 8.5%/dollar (i.e., on average, each dollar more spent on coffee will yield an increase of 8.5% in product benefit efficiency score). Armed with this knowledge, and knowledge of a plurality of alternative coffee products available on the market, and their prices and product benefit efficiency scores, an application could determine one or more coffee products that are more sustainable than Coffee A, i.e., have higher product benefit efficiency scores. The application could then calculate product benefit efficiency improvement per dollar rates for each of those coffee products with respect to Coffee A. For example, Coffee B may have a product benefit efficiency score of 60% and may cost $3 per lb., while Coffee C has a product benefit efficiency score of 65% and has a cost of $4 per lb. The product benefit efficiency improvement rate for Coffee B can be calculated as:

(60%−50%)/($3−$2)=10%/$1=10% per dollar.

The improvement from Coffee A to Coffee B is 10% per dollar. This rate is above the average rate for coffee. As such, the application may recommend that the user change from Coffee A to Coffee B based on the fact that the improvement per dollar for this change would be higher than the average improvement per dollar for the product category.

The product benefit efficiency improvement rate for Coffee C with respect to Coffee A can be calculated as:

(65%−50%)/($4−$2)=15%/$2=7.5% per dollar

In this case, the rate of improvement per dollar for Coffee C with respect to Coffee A is only 7.5% per dollar, which is below the average. In various embodiments, the application may not recommend this change based on the fact that this improvement rate is lower than the average improvement rate for the product category. In certain embodiments, the application may calculate product benefit efficiency improvement per dollar rates for a plurality of alternative products, and may display a list of alternative product options ranked based on improvement rate. The user can then identify which product they wish to change to based on the information presented.

In certain embodiments, a user can be presented with a set of products that the user currently purchased in various product categories. For each product category, one or more recommendations can be made for potential alternative products to switch to. Each recommendation can be presented with an associated improvement rate, and the user can also be shown the average improvement rate for each category, so that the user can identify one or more products in one or more product categories to switch products.

In certain embodiments, rather than calculating an average product benefit efficiency improvement per dollar spent within a particular product category, this metric can be calculated across multiple product categories, or across all product categories. Then the improvement from one product to another can be compared to the average improvement rate for multiple and/or all categories to determine whether a change from one product to another would be sensible.

In another embodiment, not only can the system compare in this way across product categories but the system can also compare over the whole basket of products for different impact areas. Therefore the system can work out the price of offsetting another percentage point of soil or water both over all products in all product categories and within each individual product category.

Green Spend Efficiency Improvement

Another improvement metric that can be measured is improvement in green spend efficiency with increased spend. As noted above, each product within a product category can be plotted based on price and product benefit efficiency score. Furthermore, as also described above, each product category may have a product benefit efficiency score threshold which determines which products within a product category are “green” (or recommended). An organization may have a current set of products which they are purchasing across a plurality of product categories, and a green spend efficiency can be calculated for the organization based on the products purchased.

The system can be configured to identify a set of one or more products in an organization's current set of products that are not “green” products, i.e., a set of “non-green” products. The application can identify one or more alternative products for each product in the set of non-green products, where each alternative product is a green product. The application can also calculate how much additional spend would be required for the organization to switch from a non-green product to a green product, and the resulting improvement in green spend efficiency if the switch was to be made. The organization can be provided with recommendations for product switches that would result in the greatest improvement in green spend efficiency for the least money.

Consider this example. An organization's current product purchases can be summarized as follows:

| | | | Total # | | |
|---|---|---|---|---|---|
| Product | Product | Price Per | of units | Total | Green |
| Category | Name | Unit | purchased | spend | product? |
| Paper | Paper A | $5/case | 100 | $500 | No |
| Coffee | Coffee A | $2/pound | 300 | $600 | No |
| Computers | Computer A | $200/unit | 5 | $1000 | No |

In this example, the organization's current spend is $2100, and their green spend efficiency is 0%, because none of their products are green products. Now, consider the following set of alternative products that are available on the market:

| | | | Total # | Total | |
|---|---|---|---|---|---|
| Product | Product | Price Per | of units | projected | Green |
| Category | Name | Unit | needed | spend | product? |
| Paper | Paper B | $6/case | 100 | $600 | Yes |
| Coffee | Coffee B | $2.50/pound | 300 | $750 | Yes |
| Computers | Computer B | $230/unit | 5 | $1150 | Yes |

Switching from Paper A to Paper B would cost $1/case, and $100 in total spend. As such, if this single change was made, the organization's total spend would increase from $2100 to $2200, but its green spend efficiency would increase from 0% to $600/$2200=27%. In other words, the organization could spend $100 to increase green spend efficiency by 27%. The rate of improvement would be 27%/$100=0.27% per dollar.

Switching from Coffee A to Coffee B would cost $0.50 per pound, and $150 more in total spend. If this change was made, the organization's total spend would increase from $2100 to $2250, but its green spend efficiency would increase from 0% to $750/$2250=33%. The rate of improvement would be 33%/$150=0.22% per dollar.

Switching from Computer A to Computer B would cost $30 per computer, and $150 more in spend. If this change was made, the organization's total spend would increase from $2100 to $2250, but its green spend efficiency would increase from 0% to $1150/$2250=51%. The rate of improvement would be 51%/$150=0.34% per dollar.

In various embodiments, a user can be presented with these metrics (e.g., in a user interface), so that the user can determine which products to improve. For example, in the example scenario above, a user may decide that upgrading its computers is the best use of additional funds, as it would result in the greatest increase in green spend efficiency per dollar.

Consider another example scenario:
1. Category A product has a current score of 35% and costs $20. Threshold=37%
2. Category B product has a current score of 80% and costs $15. Threshold=95%
3. Spending one dollar extra on category A leads to a gain of 5%. This totals 35+5=40% which would put the category above the green threshold.
4. Spending one dollar extra on category B leads to a gain of 10%. This totals 80+10=90% and wouldn't be above the green threshold.

Therefore, even though a larger score can be gained in category B with an extra dollar spent it makes more sense to spend the money on category A because the threshold for green is lower and the standards are lower in the product category A.

In various embodiments, each of the metrics and recommendations described above can be performed automatically by a computer application, and any information and/or recommendations can be presented to a user in a graphical user interface.

In some embodiments, the system can highlight both savings and gains. Savings correspond to potential savings in spend for fixed green spend efficiency scores. Gains correspond to improvements for fixed price in the green spend efficiency score. Average can be calculated, for example, over impact areas within a product category, over all products in all product categories, within specific purchasing departments or seasonal/temporal periods.

### Example for Impact Areas

Gains. Assume that the average price for a 1% gain in water impacts across all product categories is $10. At any point at which the price is cheaper than $10 for 1% or more is considered a worthwhile purchase.

### Example for Product Category

Gains. Assuming the average price for a 1% gain in paper across all impacts is $10. At any point at which the price is cheaper than $10 for 1% or more is considered a worthwhile purchase.

The recommendation engine 224 may function to determine product recommendations 252. As discussed elsewhere herein, the data annotation engine 112 may aggregate raw data, and annotate the data in order to derive a structured data set of a plurality of product categories, and related practices and impact areas associated with each product category. As discussed elsewhere herein, the similarity engine 214 may use of the structured data to identify similar practices based on impact areas associated with those practices.

As discussed elsewhere herein, the sustainability inference engine 216 may leverage the identification of similar practices determined by the similarity engine 214 to determine product categories that are similar. Relatedly, practices were inferred from one stage of a first product category to the same stage in a second product category determined to be similar to the first product category. Such inferences may be beneficial where, for example, practice data is missing for a product category (e.g., there was not sufficient raw data for that particular product category to determine practices for certain stages in that product category's development cycle).

Referring back to the recommendation engine 224, an example embodiment is provided in which “best practices” for a product category are determined. In certain embodiments, these best practices can be provided as recommendations to various organizations to assist the organizations in crafting purchasing/environmental policies. In various embodiments, determinations of “best practices” are made based on crowd intelligence and/or network-based reasoning.

### Approach 1: Finding Best Practices Based on Reputation and Crowd Intelligence

In a bottom-up, peer-to-peer network of organizations who all claim to have an authority on defining what sustainability might mean, often to serve their own interests, the present disclosure provides for an alternative approach to product information management for use in all of procurement and merchandising using value engineering technologies that reconcile cost, quality, and sustainability for use in procurement intelligence, marketing intelligence, and manufacturing intelligence.

The present disclosure provides for an approach to search that ranks practices/products based on the popularity of the practice in the current field of specifications. For example, in certain embodiments, the ranking that a practice attains depends on both the number of times that the practice is referenced in specifications and whether that particular practice appears alongside other practices for that particular product category. By inferring similarities between practices across specifications, the system can bucket practices and hence classify the most popular. The next step in determining the best in class of any given product category is to transfer this frequency popularity/scoring from popular criteria onto criteria that the system deems similar or connected to that practice via an overarching specification, such as an ecolabel. In some embodiments, the scoring system may utilize/implement the following equation:

Pop(p)=sum_{k}Pop(k)/Links(k), for all k in the set of practices.

Where Pop(p) is the popularity of a particular practice, p, and Link(k) measure the number of connections. The Links function is a weighting for each practice which can both increase and reduce its significance in impacting on the popularity of other practices.

The determination of significance for criteria/practices for a product category can be represented as a two-step process:
1. Practices are classified and marked as similar both within and across product categories. Similarity is determined in a dynamic way with the concept of similarity moving as data coverage and confidence increases. See above (e.g., with reference to similarity engine 214), for a detailed explanation of the methodology for determining similarity between practices.
2. Using the structured data database discussed above, the system can measure the popularity of practices by recording the number of times they are referenced in specifications but with the caveat that practices are deemed more popular if they are referenced frequently and appear alongside more practices.

This approach seeks to ensure that the practices deemed popular are both common within the market of relevant specifications but also important in that they are viewed as being significant in addressing a particular area of concern, i.e. impact area.

### Example

| | Practice 1 | Practice 2 | Practice 3 | Practice 4 |
|---|---|---|---|---|
| Ecolabel A | 1 | 1 | 0 | 0 |
| Ecolabel B | 1 | 0 | 1 | 1 |
| Ecolabel C | 1 | 1 | 0 | 1 |
| Ecolabel D | 1 | 0 | 0 | 1 |

Links(1) = “How many times is Practice 1 referenced in the specifications”

= 4

Links(2) = 2
Links(3) = 1
Links(4) = 3

In some embodiments, the system can use the link values to determine a popularity (Pops) value for each practice:

$$\begin{matrix}Pop ( 3 ) = sum\_ \{ k \} Pop ( k ) / Links ( k ) \\ = Pop ( 1 ) / Links ( 1 ) + Pop ( 4 ) / Links ( 4 ) \\ = Pop ( 1 ) / 4 + Pop ( 4 ) / 3\end{matrix}$$

$$Pop ( 2 ) = Pop ( 1 ) / 4 + Pop ( 4 ) / 3 + Pop ( 3 ) / 2$$

$$Pop ( 4 ) = Pop ( 1 ) / 4 + Pop ( 2 ) / 2 + Pop ( 3 ) / 2$$

$$Pop ( 1 ) = Pop ( 2 ) / 2 + Pop ( 3 ) / 2 + Pop ( 4 ) / 3$$

The system may seed the lowest linked practice with a non-zero value (e.g., 1) to ensure the solution exists. In this case, Practice 3 is the lowest linked practice, so Pop(3) is set to 1. The system may then have three equations for three unknowns that can be trivially solved to show that:
Pop(1)=3.7
Pop(2)=3
Pop(3)=1
Pop(4)=3.5

As expected the top two practices are numbers 1 and 4. In this case number one is deemed more popular as it appears more frequently in ecolabels, however they are both close in popularity because they are referenced by all other practices. Practice 2 falls short because it appears in less ecolabels and does not appear alongside practice 3.

The above example illustrates the case in which there are similar practices within a product category across multiple ecolabels. However a further embodiment involves attributing significance to practices which aren't similar but reside in the same ecolabel as practices deemed significant using the previous algorithm.

To make this calculation, the system may “seed” practices with a weighting which ensures they are considered above average to begin with when calculating significance for practices moving forward. To do this the system may follow the algorithm above but within an ecolabel to attribute significance internally to all practices. Then when system compares across ecolabels these weights and multiply the popularity score as follows:

Pop(p)=sum_{k}weight(k)*Pop(k)/Links(k), for all k in the set of practices where sum_{L}weight(L)=1 within an ecolabel of practices from 1. . . L.

In various embodiments, the system may normalize the weights within an ecolabel to sum to 1 ensuring that they can be thought of as a probability distribution within the ecolabel.

Approach 2: Finding Best Practices Based on Identifying Value Created with Differing Costs (e.g., Based on True Value/True Cost

In addition to, or instead of, using the popularity scoring approach above the system can also infer best practices based on cost. In this case the system may seek to normalize across various features within similar products with the intention of inferring technological innovation based on the price differential between competing products. An example will illustrate our methodology:

### Example

Consider two products within the same product category which are manufactured by different vendors. The system can assume that both manufacturers are of similar size in terms of market capitalization and operate similar business models. Controlling for these features allows the system and/or users to the assume that economies of scale are not playing a role in pricing.

Now consider the following data:

| | Paper A | Paper B |
|---|---|---|
| Price | $10 | $3 |
| Product Benefit Efficiency Score | 70% | 30% |
| Eco-specifications | Practice 1 | Practice 2 |
| | $14.28 true cost | $10 true cost |
| | $4.28 external | $7 external |

Despite their prices being different, they have similar product benefit efficiency scores. An assumption is that this is because Practice 1 is a more advanced innovation than Practice 2. Therefore system may recommend this Practice 1 over Practice 2 for this particular product category. To ensure that this method has validity, the system may average over the full dataset of products within each category to find average prices of practices to achieve offsets for certain impact liabilities. Given this information, the system may bucket the practices into high, medium and low offsets where the bucketing splits the price range into three equal quadrants.

The above example demonstrates how, once similar practices are identified, the system may can identify a method of popularity or significance. With this information the system may then tailor recommendations to our users when they wish to offset a particular liability (e.g., impact area).

The communication engine 226 may function to send requests, transmit and, receive communications, and/or otherwise provide communication with one or a plurality of systems. In some embodiments, the communication engine 226 functions to encrypt and decrypt communications. The communication engine 226 may function to send requests to and receive data from one or more systems through a network or a portion of a network. Depending upon implementation-specified considerations, the communication engine 226 may send requests and receive data through a connection, all or a portion of which may be a wireless connection. The communication engine 226 may request and receive messages, and/or other communications from associated systems. Communications may be stored at least temporarily (e.g., cached and/or persistently) in a datastore of the augmented sustainability management and analytics system 102 and/or remote system associated therewith.

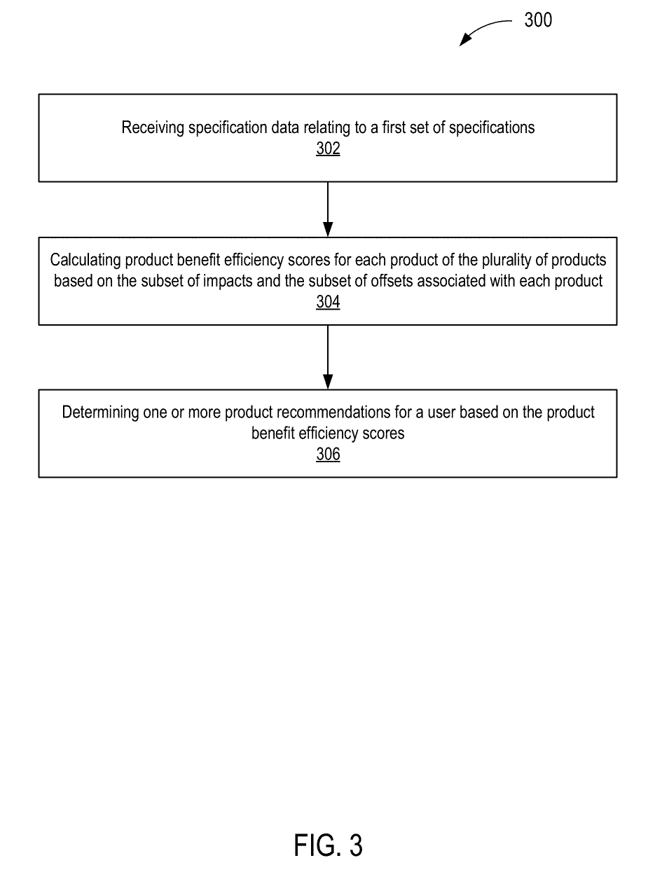

FIG. 3 depicts a flowchart 300 of an example of a method of determining one or more product recommendations for a user based on product efficiency scores according to some embodiments. The flowchart 300 illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 302, a computing system (e.g., augmented sustainability management and analytics system 102) receives specification data (e.g., specification data 240) relating to a first set of specifications. In some embodiments, a communication engine (e.g., communication engine 226) receives the specification data over a communications network (e.g., communications network 106), and a management engine (e.g., management engine 202) stores the specification data in a datastore (e.g., specification information datastore 206). The specification data may comprise a plurality of product categories (e.g., product categories 242), a plurality of impact areas (e.g., impact areas 244) associated with each product category of the set of product categories, a plurality of offsets (e.g., offsets 246), each offset associated with an impact area, and a plurality of products (e.g., products 248), each product associated with a subset of impact areas of the plurality of impact area and a subset of offsets of the set of offsets.

In step 304, the computing system calculates product benefit efficiency scores (e.g., product benefit efficiency scores 250) for each product of the plurality of products based on the subset of impact areas and the subset of offsets associated with each product. In some embodiments, a benefit efficiency scoring engine (e.g., benefit efficiency scoring engine 218) calculates the scores.

In some embodiments, the product benefit efficiency score for a product is indicative of a sustainability of the product. In some embodiments, the product benefit efficiency score for a product is indicative of how effectively the set of offsets associated with the product offset the set of impact areas associated with the product.

In step 306, the computing system determines one or more product recommendations (e.g., product recommendations 252) for a user (e.g., user system 104) based on the product benefit efficiency scores. In some embodiments, a recommendation engine (e.g., recommendation engine 224) determines the one or more product recommendations, and the communication engine provides the one or more product recommendations over the communications network to the user.

In some embodiments, determining one or more product recommendations for the user based on the product benefit efficiency scores comprises determining one or more product recommendations for the user is based on one or more true values. The true values may be calculated by a true value engine (e.g., true value engine 220). In some embodiments, a true value for a product comprises a quotient of a price associated with the product divided by a product benefit efficiency score associated with the product.

In some embodiments, determining one or more product recommendations for the user is based on the product benefit efficiency scores comprises determining one or more product recommendations for a user based on product benefit efficiency score thresholds. The product benefit efficiency score thresholds may be calculated by the benefit efficiency scoring engine.

In some embodiments, the computing system receiving purchase order information associated with a purchase order made by the user. The purchase order information may comprise one or more products purchased by the user, an amount of spend for each product of the one or more products, and a total spend for the purchase order. The computing may calculate a green spend efficiency for the set of purchases. The green spend efficiency may be indicative of a proportion of the total spend that was spent on products that satisfy the product benefit efficiency score threshold. In some embodiments, a benefit inference engine (e.g., benefit inference engine 222) calculates the green spend efficiency.

In some embodiments, the computing receiving current receives product information comprising a set of products that have been previously purchased by the user, the set of products comprising products within a plurality of product categories. The computing system may identify alternative product recommendations for at least a subset of the set of products based on the product benefit efficiency scores. In some embodiments, the communication engine receives the product information, and the recommendation engine identifies the alternative product recommendations.

In some embodiments, the recommendation engine identifies alternative product recommendations for at least a subset of the set of products comprises calculating at least one of a product benefit efficiency score improvement rate or a green spend efficiency improvement rate for each product in the subset of products and the alternative product recommendations.

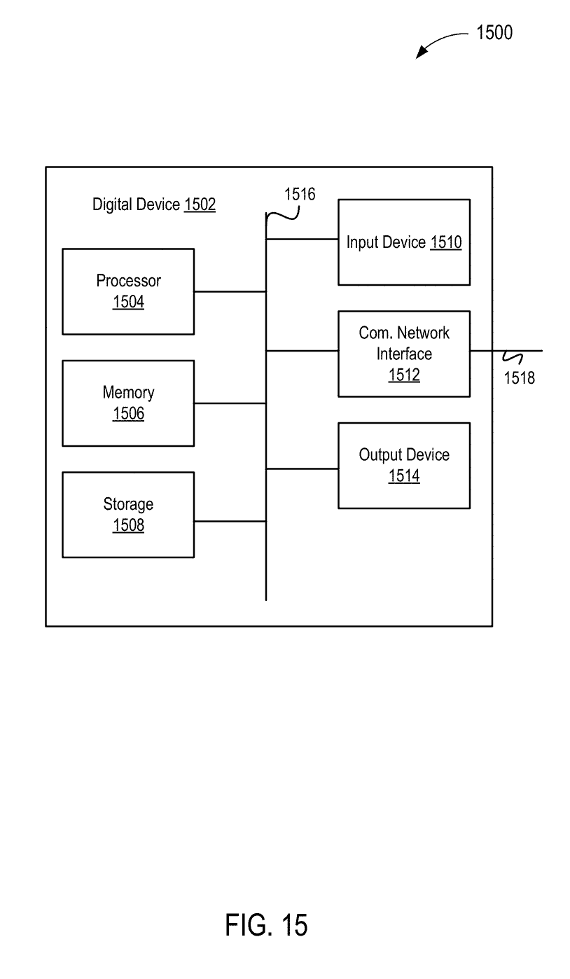

FIG. 15 depicts a diagram 1500 of an example of a computing device 1502. Any of the systems 102-104, and the communication network 106 may comprise an instance of one or more computing devices 1502. The computing device 1502 comprises a processor 1504, memory 1506, storage 1508, an input device 1510, a communication network interface 1512, and an output device 1514 communicatively coupled to a communication channel 1516. The processor 1504 is configured to execute executable instructions (e.g., programs). In some embodiments, the processor 1504 comprises circuitry or any processor capable of processing the executable instructions.

The memory 1506 stores data. Some examples of memory 1506 include storage devices, such as RAM, ROM, RAM cache, virtual memory, etc. In various embodiments, working data is stored within the memory 1506. The data within the memory 1506 may be cleared or ultimately transferred to the storage 1508.

The storage 1508 includes any storage configured to retrieve and store data. Some examples of the storage 1508 include flash drives, hard drives, optical drives, cloud storage, and/or magnetic tape. Each of the memory system 1506 and the storage system 1508 comprises a computer-readable medium, which stores instructions or programs executable by processor 1504.

The input device 1510 is any device that inputs data (e.g., mouse and keyboard). The output device 1514 outputs data (e.g., a speaker or display). It will be appreciated that the storage 1508, input device 1510, and output device 1514 may be optional. For example, the routers/switchers may comprise the processor 1504 and memory 1506 as well as a device to receive and output data (e.g., the communication network interface 1512 and/or the output device 1514).

The communication network interface 1512 may be coupled to a network (e.g., network 106) via the link 1518. The communication network interface 1512 may support communication over an Ethernet connection, a serial connection, a parallel connection, and/or an ATA connection. The communication network interface 1512 may also support wireless communication (e.g., 802.11 a/b/g/n, WiMax, LTE, WiFi). It will be apparent that the communication network interface 1512 may support many wired and wireless standards.

It will be appreciated that the hardware elements of the computing device 1502 are not limited to those depicted in FIG. 15. A computing device 1502 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1504 and/or a co-processor located on a GPU (e.g., an Nvidia co-processor).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

In some embodiments, terms used herein are defined as follows:
(M)SDS: (Material) Safety Data Sheets—SDS information may include instructions for the safe use and potential hazards associated with a particular material or product.
Accreditation: Third Party process to assess a laboratory of a conformity assessment body for competence, impartiality, technical and management requirements
ACE: Auto categorization engine
ANSI: American National Standards Institute
B&L: Benefits and liabilities
CAB: Conformity Assessment Body
Conformity Assessment: Processes used to verify the compliance of a person, process, product, service, or system to either a standard or a regulation (eg. testing, certification, inspection)
Design Standard: Requirements expressed in terms of specific design requirements such as materials, construction, and dimensions
Ecolabel: Identifies products or services proven environmentally preferable overall, within a specific product or service category.
EO: Executive Order
EPA: Environmental Protection Agency
EPD: Environmental Product Declaration
EPP: Environmentally Preferable Purchasing
ERP System: Enterprise Resource Planning Systems are the transactional systems (e.g., SAP, Oracle, JDEdwards, PeopleSoft) by which large organizations procure products and make a purchase record digitally.
FAR: Federal Acquisition Regulation—Outlines mandatory federal sustainability purchasing requirements
NIST: National Institute of Standards and Technology
NTTA: National Technology Transfer and Advancement Act 1996—Directs federal purchasers
OMB Circular A-119: Office of Management and Budget—Covers federal participation in the development and use of voluntary consensus standards and in conformity assessment activities
P-card: Purchase card—credit card system used by city purchasers
PO: Purchase order
RFI: Request for Information—Governments use this to find out prices or what is available to purchase in the market place
RFP: Request for Proposal—Governments create this when they want to procure particular products and services
RFQ: Request for Quotation—Invitation for suppliers to provide information on specific products or services
SDO: Standard Development Organization
Standard: Technical specification for a person, process, product, service, or system—compliance is voluntary
Technical Regulation: Technical specification for a person, process, product, service, or system—compliance is MANDATORY
UNSPSC: United Nations Standard Products and Services Code
VCS: Defines how the standard is developed. Voluntary Consensus Standard—meaning a standard was development with well-rounded stakeholders and was approved by consensus
Green Spend Efficiency: The proportion of spend which is green. A green product is one that is defined as having a product benefit efficiency score above the threshold for its product category.
Product Benefit Efficiency Score: The number of weighted liabilities offset by the criteria included in the environmental product declarations of a product expressed as a percentage.
Benefit Efficiency Score: The number of weighted liabilities offset by the criteria included in the policy expressed as a percentage.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A computer-implemented method comprising:
receiving, by a computing system, specification data relating to a first set of specifications, the specification data comprising:
a plurality of product categories,
a plurality of impact areas associated with each product category of the plurality of product categories,
a plurality of offsets, each offset associated with an impact area, and
a plurality of products, each product associated with a subset of impact areas of the plurality of impact areas and a subset of offsets of the plurality of offsets;
calculating, by the computing system, product benefit efficiency scores for each product of the plurality of products based on the subset of impact areas and the subset of offsets associated with each product; and
determining, by the computing system, one or more product recommendations for a user based on the product benefit efficiency scores.

2. The computer-implemented method of claim 1, wherein the product benefit efficiency score for a product is indicative of a sustainability of the product.

3. The computer-implemented method of claim 2, wherein the product benefit efficiency score for a product is indicative of how effectively the subset of offsets associated with the product offset the subset of impact areas associated with the product.

4. The computer-implemented method of claim 1, further comprising:
determining that a first product category of the plurality of product categories is similar to a second product category of the plurality of product categories; and
associating one or more impact areas associated with the second product category with the first product category based on the determining that the first product category is similar to the second product category.

5. The computer-implemented method of claim 1, further comprising:
calculating a true value for at least some products of the plurality of products, wherein
the determining the one or more product recommendations for the user based on the product benefit efficiency scores comprises determining one or more product recommendations for the user based on the true values.

6. The computer-implemented method of claim 5, wherein the true value for a product comprises a quotient of a price associated with the product divided by the product benefit efficiency score associated with the product.

7. The computer-implemented method of claim 1, further comprising:
calculating a product benefit efficiency score threshold for each product category of the plurality of product categories based on the product benefit efficiency scores, wherein
the determining the one or more product recommendations for the user based on the product benefit efficiency scores comprises determining one or more product recommendations for the user based on the product benefit efficiency score thresholds.

8. The computer-implemented method of claim 7, further comprising:
receiving purchase information associated with a purchase made by the user, the purchase information comprising one or more products purchased by the user, an amount of spend for each product of the one or more products, and a total spend for the purchase; and
calculating a green spend efficiency for the purchase, wherein the green spend efficiency is indicative of a proportion of the total spend that was spent on products that satisfy the product benefit efficiency score threshold.

9. The computer-implemented method of claim 8, further comprising:
receiving current product information comprising a set of products that have been previously purchased by the user, the set of products comprising products within a plurality of product categories; and
identifying alternative product recommendations for at least a subset of the set of products based on the product benefit efficiency scores.

10. The computer-implemented method of claim 9, wherein the identifying alternative product recommendations for at least the subset of the set of products comprises calculating at least one of a product benefit efficiency score improvement rate or a green spend efficiency improvement rate for each product in the subset of products and the alternative product recommendations.

11. A system comprising:
at least one processor; and
memory storing instructions that, when executed by the at least one processor, cause the system to perform a method comprising:
receiving specification data relating to a first set of specifications, the specification data comprising
a plurality of product categories,
a plurality of impact areas associated with each product category of the plurality of product categories,
a plurality of offsets, each offset associated with an impact area, and
a plurality of products, each product associated with a subset of impact areas of the plurality of impact area and a subset of offsets of the plurality of offsets;
calculating product benefit efficiency scores for each product of the plurality of products based on the subset of impact areas and the subset of offsets associated with each product; and
determining one or more product recommendations for a user based on the product benefit efficiency scores.

12. The system of claim 11, wherein the product benefit efficiency score for a product is indicative of a sustainability of the product.

13. The system of claim 12, wherein the product benefit efficiency score for a product is indicative of how effectively the subset of offsets associated with the product offset the subset of impact areas associated with the product.

14. The system of claim 11, wherein the method further comprises:
determining that a first product category of the plurality of product categories is similar to a second product category of the plurality of product categories; and
associating one or more impact areas associated with the second product category with the first product category based on the determining that the first product category is similar to the second product category.

15. The system of claim 11, wherein the method further comprises:
calculating a true value for at least some products of the plurality of products, wherein
the determining the one or more product recommendations for the user based on the product benefit efficiency scores comprises determining one or more product recommendations for the user based on the true values.

16. A non-transitory computer-readable storage medium including instructions that, when executed by at least one processor of a computing system, cause the computing system to perform a method comprising:
receiving specification data relating to a first set of specifications, the specification data comprising
a plurality of product categories,
a plurality of impact areas associated with each product category of the plurality of product categories,
a plurality of offsets, each offset associated with an impact area, and
a plurality of products, each product associated with a subset of impact areas of the plurality of impact area and a subset of offsets of the plurality of offsets;
calculating product benefit efficiency scores for each product of the plurality of products based on the subset of impact areas and the subset of offsets associated with each product; and
determining one or more product recommendations for a user based on the product benefit efficiency scores.

17. The non-transitory computer-readable storage medium of claim 16, wherein the product benefit efficiency score for a product is indicative of a sustainability of the product.

18. The non-transitory computer-readable storage medium of claim 17, wherein the product benefit efficiency score for a product is indicative of how effectively the subset of offsets associated with the product offset the subset of impact areas associated with the product.

19. The non-transitory computer-readable storage medium of claim 16, wherein the method further comprises:
determining that a first product category of the plurality of product categories is similar to a second product category of the plurality of product categories; and
associating one or more impact areas associated with the second product category with the first product category based on the determining that the first product category is similar to the second product category

20. The non-transitory computer-readable storage medium of claim 16, wherein the method further comprises:
calculating a true value for at least some products of the plurality of products, wherein the determining the one or more product recommendations for the user based on the product benefit efficiency scores comprises determining one or more product recommendations for the user based on the true values.
